(19) United States
(12) Patent Application Publication
(10) Pub. No.: US 2026/0177970 A1
(43) Pub. Date: Jun. 25, 2026

(54) IMAGE FORMING APPARATUS

(71) Applicant: CANON KABUSHIKI KAISHA, Tokyo (JP)

(72) Inventors: TERUHIKO SASAKI, Shizuoka (JP); AKINOBU HIRAYAMA, Shizuoka (JP); YOSHIYUKI YAMAZAKI, Okinawa (JP); OSAMU NAGASAKI, Shizuoka (JP); TAKANORI YAMAMOTO, Shizuoka (JP); MOTOHIRO FURUSAWA, Shizuoka (JP)

(21) Appl. No.: 19/420,505

(22) Filed: Dec. 15, 2025

(30) Foreign Application Priority Data
Dec. 19, 2024 (JP) 2024-224576
Apr. 7, 2025 (JP) 2025-062895

(51) Int. Cl. G03G 21/12; G03G 21/00; G03G 21/10; G03G 21/16; G03G 21/18

(52) U.S. Cl. CPC G03G 21/12; G03G 21/0011; G03G 21/105; G03G 21/1647; G03G 21/1652; G03G 21/1814; G03G 2221/1606; G03G 2221/166

(57) ABSTRACT

An image forming apparatus includes an apparatus main body, a transfer roller, a cartridge which is attachable and detachable in a first direction, the cartridge including a photosensitive drum, a blade which scrapes residual toner remaining on the photosensitive drum without being transferred to a recording material, and a development roller, a residual toner container which is attachable to and detachable from the apparatus main body in a second direction and is configured to contain the residual toner scraped from the photosensitive drum by the blade, and a first exterior member which covers an end surface in the second direction of one end portion of the apparatus main body from outside, wherein the residual toner container is provided with a second exterior member which covers an end surface of the apparatus main body from outside.

### BACKGROUND

### Field of the Technology

The present disclosure relates to an image forming apparatus which forms an image on a recording material.

### Description of the Related Art

Japanese Patent Laid-Open No. 2010-152252 describes a waste-toner container which recovers, as waste toner, an adhered material such as toner having remained on a photosensitive drum without being transferred to a recording material and an electrophotographic type image forming apparatus which detects the fullness, mounting, and demounting of the waste-toner container with use of an optical sensor.

### SUMMARY

The present disclosure is directed to a new technique which has been obtained by developing the background art concerning the retrieval of residual toner which has not been transferred to a recording material.

According to some embodiments of the present disclosure, an image forming apparatus includes an apparatus main body, a transfer roller, a cartridge which is attachable to and detachable from the apparatus main body in a first direction intersecting with a direction of gravitational force, the cartridge including a photosensitive drum which rotates around a rotational axis extending in a second direction intersecting with both the first direction and the direction of gravitational force, the photosensitive drum being configured to form a transfer nip portion for transferring a toner image to a recording material in conjunction with the transfer roller, a blade which is in abutting contact with the photosensitive drum, the blade being configured to scrape residual toner remaining on the photosensitive drum without being transferred to the recording material, and a development roller configured to supply toner to the photosensitive drum, a toner container which is attachable to and detachable from the apparatus main body, the toner container being configured to contain toner to be supplied to the cartridge, a residual toner container which is attachable to and detachable from the apparatus main body in the second direction independently from the toner container and is configured to contain the residual toner scraped from the photosensitive drum by the blade, the residual toner container being provided at one end portion in the second direction of the apparatus main body, and a first exterior member which covers an end surface in the second direction of the one end portion of the apparatus main body from outside, wherein the residual toner container is provided with a second exterior member which covers the end surface of the apparatus main body from outside.

According to another aspect of the present disclosure, an image forming apparatus includes an apparatus main body, a transfer roller, a drum cartridge which is attachable to and detachable from the apparatus main body in a first direction intersecting with a direction of gravitational force, the drum cartridge including a photosensitive drum which rotates around a rotational axis extending in a second direction intersecting with both the first direction and the direction of gravitational force, the photosensitive drum being configured to form a transfer nip portion for transferring a toner image to a recording material in conjunction with the transfer roller, and a blade which is in abutting contact with the photosensitive drum, the blade being configured to scrape residual toner remaining on the photosensitive drum without being transferred to the recording material, a development cartridge which is attachable to and detachable from the drum cartridge and is attachable to and detachable from the apparatus main body while being mounted to the drum cartridge, the development cartridge including a development roller configured to supply toner to the photosensitive drum, a residual toner container which is attachable to and detachable from the apparatus main body in the second direction independently from the drum cartridge and the development cartridge and is configured to contain the residual toner scraped from the photosensitive drum by the blade, the residual toner container being provided at one end portion in the second direction of the apparatus main body, and a first exterior member which covers an end surface in the second direction of the one end portion of the apparatus main body from outside, wherein the residual toner container is provided with a second exterior member which covers the end surface of the apparatus main body from outside.

According to the present disclosure, it is possible to provide a new technique concerning the recovery of residual toner.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are perspective views of an image forming apparatus according to a first embodiment.

FIG. 2 is a sectional view of the image forming apparatus according to the first embodiment.

FIG. 3 is a sectional view of a process cartridge and a toner cartridge according to the first embodiment.

FIG. 4 is a perspective view of the process cartridge and the toner cartridge according to the first embodiment.

FIG. 5 is an explanatory diagram of the process cartridge and the toner cartridge according to the first embodiment.

FIG. 6 is an explanatory diagram of a contact portion of the process cartridge and a first waste-toner conveyance portion according to the first embodiment.

FIG. 7 is an explanatory diagram of a main body contact portion and a second waste-toner conveyance portion according to the first embodiment.

FIGS. 8A and 8B are sectional views of a part of the process cartridge and a part of an apparatus main body according to the first embodiment.

FIG. 9 is a sectional view illustrating a part of the process cartridge according to the first embodiment.

FIG. 10 is a perspective view illustrating a part of the process cartridge and the second waste-toner conveyance portion according to the first embodiment.

FIGS. 11A and 11B are schematic diagrams illustrating cross-sections of the second waste-toner conveyance portion and a waste-toner container according to the first embodiment.

FIG. 12 is an explanatory diagram used to explain the arrangement of the first waste-toner conveyance portion according to the first embodiment.

FIGS. 13A and 13B are perspective views of the waste-toner container according to the first embodiment.

FIG. 14 is an explanatory diagram used to explain a waste-toner container according to a second embodiment.

FIG. 15 is a perspective view of the waste-toner container according to the second embodiment.

FIGS. 16A and 16B are sectional views of a drum cartridge and a development cartridge according to a modification example.

### DESCRIPTION OF THE EMBODIMENTS

Various exemplary embodiments, features, and aspects of the present disclosure will be described in detail below with reference to the drawings.

### First Embodiment

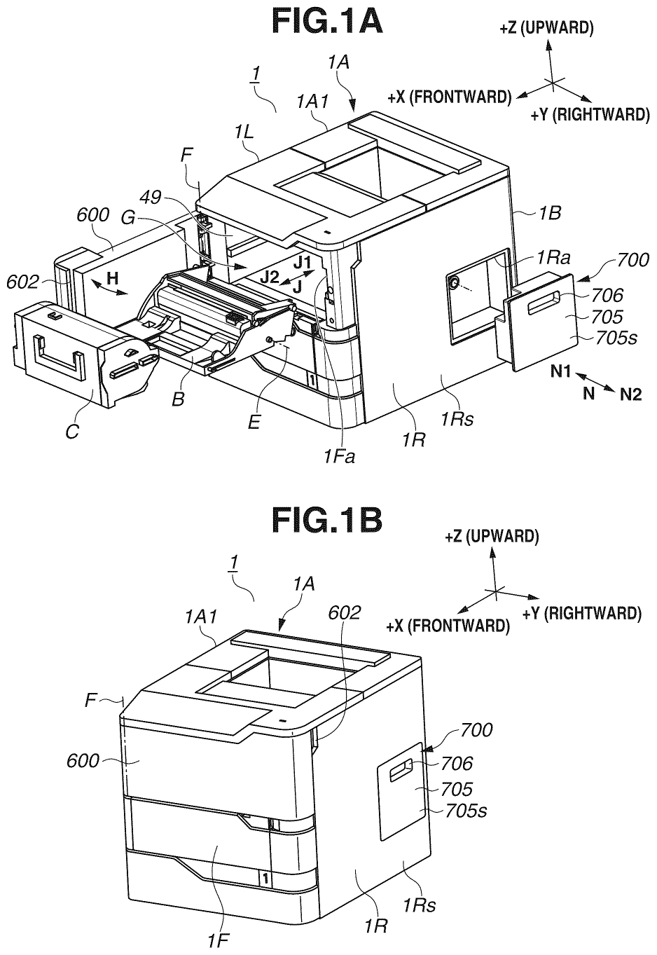

FIGS. 1A and 1B are perspective views illustrating an image forming apparatus 1 according to a first embodiment. The image forming apparatus 1 is a monochromatic laser printer, which forms an image on a sheet by performing an electrophotographic process using laser light.

In the following description, the vertical direction in a case where the image forming apparatus 1 is installed on the horizontal plane is referred to as a “Z-axis direction”. One of the horizontal directions is referred to as an “X-axis direction”. A direction perpendicular to both the Z-axis direction and the X-axis direction is referred to as a “Y-axis direction”. In the first embodiment, the X-axis direction can be called “frontward and backward directions” of the image forming apparatus 1, and the Y-axis direction can be called “width directions” or “leftward and rightward directions” of the image forming apparatus 1. When desired, the respective directions of arrows X, Y, and Z illustrated in each figure may be represented by positive signs (+) and the respective directions opposite thereto are represented by negative signs (−).

In the first embodiment, the +X direction may be called a “front side” or “front surface side” of the image forming apparatus 1, and the −X direction may be called a “back side” or “back surface side” of the image forming apparatus 1. Moreover, the right hand side (+Y direction) in a case where the image forming apparatus 1 is viewed from the front surface side may be called the “right side of the image forming apparatus 1”, and the direction opposite thereto (−Y direction) may be called the “left side of the image forming apparatus 1” (see FIGS. 1A and 1B). Moreover, the Y-axis direction is a direction of the rotational axis of a photosensitive drum 11 included in the image forming apparatus 1, and the X-axis direction is an example of a direction intersecting with the direction of the rotational axis of the photosensitive drum 11.

Moreover, units attachable to and detachable from the apparatus main body 1A of the image forming apparatus 1 (for example, a process cartridge B, a toner cartridge C, and a waste-toner container 700) are illustrated and described based on the orientations thereof in a state in which the units have been completely attached to the apparatus main body 1A.

### <External Appearance of Image Forming Apparatus>

As illustrated in FIGS. 1A and 1B, the image forming apparatus 1 includes an apparatus main body 1A, which serves as an image forming apparatus main body, and a process cartridge B, a toner cartridge C, and a waste-toner container 700, each of which is attachable to and detachable from the apparatus main body 1A.

The apparatus main body 1A in the first embodiment refers to a portion obtained by excluding the process cartridge B, the toner cartridge C, and the waste-toner container 700 from the image forming apparatus 1. The apparatus main body 1A includes a main body housing 1A1, which is provided with a front opening 1Fa, and a front door 600, which is supported by the main body housing 1A1. The front opening 1Fa is an opening via which the space contained in the main body housing 1A1 is opened toward the front.

The main body housing 1A1 is an approximately rectangular-shaped housing provided with a frame member such as a sheet-metal frame.

To the main body housing 1A1, a front cover 1F, which forms a front-side appearance surface of the image forming apparatus 1, a back cover 1B, which forms a back-side appearance surface of the image forming apparatus 1, a right cover 1R, which forms a right-side appearance surface of the image forming apparatus 1, and a left cover 1L, which forms a left-side appearance surface of the image forming apparatus 1, are mounted. The covers 1F, 1B, 1R, and 1L are exterior members which cover the respective end surfaces of the apparatus main body 1A. For example, the right cover 1R is an example of a first exterior member which covers, from outside, the end surface of one end portion (right-side end portion) of the apparatus main body 1A in the direction of the rotational axis E of the photosensitive drum 11 (second direction).

The front door 600 is capable of turning around a rotational shaft F thereof. The front door 600 is an opening and closing member which is movable between an opening position (FIG. 1A) for opening the front opening 1Fa and a closing position (FIG. 1B) for closing the front opening 1Fa. The front opening 1Fa is an opening which enables an access to a mounting space G provided inside the main body housing 1A1 and arranged to house the process cartridge B and the toner cartridge C therein.

The rotational shaft F of the front door 600 in the first embodiment is arranged at the left end side (first end side) of the apparatus main body 1A in the leftward and rightward directions (Y-axis direction). In a case where the rotational axis E of the photosensitive drum 11 is referred to as a first rotational axis, the rotational shaft F can be called a “second rotational axis”. The second rotational axis extends in the direction of gravitational force at the other end portion (left-side end portion) located at a side opposite to one end portion (right-side end portion) of the apparatus main body 1A at which the waste-toner container 700 is located as viewed in the direction of the rotational axis E of the photosensitive drum 11 (second direction).

The front door 600 is provided with, on the side opposite to the rotational shaft F as viewed in the leftward and rightward directions, a grip portion 602, which is arranged to be gripped to open and close the front door 600. The user can open and close the front door 600 by gripping the grip portion 602 and then turning the grip portion 602 in rotation directions H around the rotational shaft F. In a case where the front door 600 is in the opening position, the mounting space G is exposed as viewed from front to back. Thus, in a case where the front door 600 is in the closing position, the front opening 1Fa is opened in such a manner that the process cartridge B (cartridge) and the toner cartridge C (toner container) are allowed to be attached to and detached from the apparatus main body 1A through the front opening 1Fa (opening portion).

The process cartridge B and the toner cartridge C are attachable to and detachable from the apparatus main body 1A in mounting and demounting directions J along the frontward and backward directions (X-axis direction). The direction which is included in the mounting and demounting directions J and is a direction in which the process cartridge B and the toner cartridge C are mounted to the apparatus main body 1A is referred to as a “mounting direction J1 of the process cartridge B and the toner cartridge C”. The direction opposite to the mounting direction J1 is referred to as a “demounting direction J2 of the process cartridge B and the toner cartridge C”.

The process cartridge B is an example of a cartridge which is attachable to and detachable from the apparatus main body 1A in the first direction, which intersects with the direction of gravitational force. The toner cartridge C is an example of a toner container which is attachable to and detachable from the cartridge, is attachable to and detachable from the apparatus main body 1A while being mounted to the cartridge, and contains toner to be supplied to the cartridge. Thus, in the first embodiment, the toner cartridge C is attached to and detached from the apparatus main body 1A in the state in which the process cartridge B has been mounted to the apparatus main body 1A.

The mounting and demounting directions J are directions intersecting with (favorably, perpendicular to) the direction of the rotational shaft F of the front door 600. Moreover, the direction of the rotational shaft F of the front door 600 also intersects with the direction of the rotational axis E of the photosensitive drum 11. The direction of the rotational shaft F of the front door 600 can be the Z-axis direction (direction of gravitational force).

The apparatus main body 1A includes an operation panel (not illustrated). The operation panel is capable of notifying the user of, for example, the occurrence of a jam or the replacement of the waste-toner container 700, the process cartridge B, or the toner cartridge C. Moreover, the user can use the operation panel to input setting information to the image forming apparatus 1 or instruct the image forming apparatus 1 to perform an image forming operation.

The waste-toner container 700 is attachable to and detachable from the apparatus main body 1A in the direction of the rotational axis E of the photosensitive drum 11 (second direction) independently from the toner cartridge C (toner container). The waste-toner container 700 is a residual toner container which contains residual toner scraped from the photosensitive drum 11 by a cleaning blade 17 (blade) described below. The waste-toner container 700 can also be referred to a “waste-toner cartridge” or a “waste-toner recovery unit”. The waste-toner container 700 is provided at one end portion (right-side end portion) of the apparatus main body 1A in the direction of the rotational axis E of the photosensitive drum 11 (second direction).

The waste-toner container 700 is arranged in such a way as to be attachable to and detachable from the apparatus main body 1A in mounting and demounting directions N intersecting with the mounting and demounting directions J of the process cartridge B and the toner cartridge C. The direction which is included in the mounting and demounting directions N and is a direction in which the waste-toner container 700 is mounted to the apparatus main body 1A is referred to as a “mounting direction N1 of the waste-toner container 700”. The direction opposite to the mounting direction N1 is referred to as a “demounting direction N2 of the waste-toner container 700”.

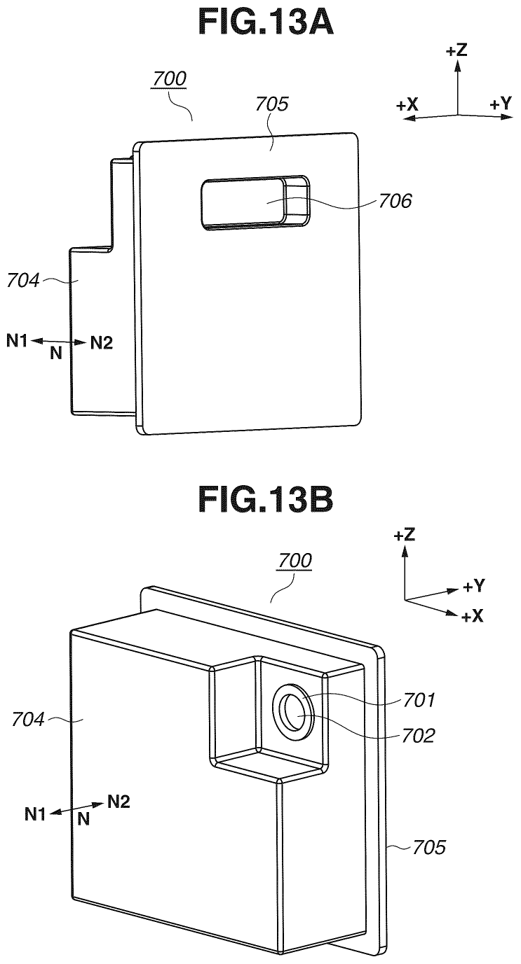

The waste-toner container 700 includes a waste-toner containing portion 704 (FIGS. 13A and 13B), which contains waste toner, an exterior member 705, which constitutes an outer appearance surface of the image forming apparatus 1 in conjunction with the exterior cover of the apparatus main body 1A, and a grip portion 706, which is used for the user to grip the waste-toner container 700.

The exterior member 705 is a second exterior member provided at the waste-toner container 700. In a state in which the waste-toner container 700 has been mounted to the apparatus main body 1A, the exterior member 705 of the waste-toner container 700 covers the right-side end surface of the apparatus main body 1A from outside. Thus, the exterior member 705 of the waste-toner container 700 forms an exterior surface on the right side (+Y direction) of the image forming apparatus 1 in conjunction with the right cover 1R.

In the right cover 1R of the apparatus main body 1A, an opening portion 1Ra, which receives a part of the waste-toner container 700, is formed. The waste-toner container 700 (residual toner container) is attachable to and detachable from the apparatus main body 1A through the opening portion 1Ra, and the exterior member 705 is mounted to the apparatus main body 1A in such a way as to block the opening portion 1Ra.

A surface 1Rs (first surface) which faces in the Y-axis direction in the right cover 1R (first exterior member) and a surface 705s (second surface) which faces in the Y-axis direction in the exterior member 705 (second exterior member) of the waste-toner container 700 can be parallel to each other. A normal vector of the broadest plane in the surface 1Rs and a normal vector of the broadest plane in the surface 705s can be coincident with each other.

Moreover, the surface 1Rs (first surface) of the right cover 1R and the surface 705s (second surface) of the exterior member 705 of the waste-toner container 700 can be located on the same plane. Thus, a configuration in which there are no steps between the surface 705s of the waste-toner container 700 and the surface 1Rs of the right cover 1R can be employed.

Moreover, the color of the surface 1Rs (first surface) of the right cover 1R and the color of the surface 705s (second surface) of the exterior member 705 of the waste-toner container 700 can be the same (identical).

The grip portion 706 is a recessed portion which is formed on the surface of the exterior member 705 (second exterior member) and the longitudinal direction of which is the mounting and demounting directions J (X-axis direction) of the process cartridge B. The user can grip the grip portion 706 and then move the waste-toner container 700 in the mounting and demounting directions N to attach or detach the waste-toner container 700 to or from the opening portion 1Ra on the right-side surface of the apparatus main body 1A.

In a case where the waste-toner container 700 is attached to or detached from the apparatus main body 1A, the exterior member 705 is attached to or detached from the apparatus main body 1A as a part of the waste-toner container 700. Thus, there is provided no opening and closing member (door or opening and closing cover) which is movable between a closing position which restricts an access to the waste-toner container 700 and an opening position which allows an access to the waste-toner container 700. If a configuration in which an openable and closable door is added to the right-side surface of the apparatus main body 1A and, after the openable and closable door is opened, the mounting and demounting of the waste-toner container 700 are performed is employed, an operation for opening and closing the door on the right-side surface occurs at the time of replacement of the waste-toner container 700. On the other hand, according to the first embodiment, since an operation for opening and closing the door on the right-side surface at the time of replacement of the waste-toner container 700 does not occur, it is possible to reduce the effort of a replacement operation and thus increase usability.

The waste-toner containing portion 704 and the exterior member 705 (second exterior member) can be integrally formed. For example, the exterior member 705 can be molded integrally with at least a part of the inner wall of the waste-toner containing portion 704 by, for example, an injection molding method. Moreover, the waste-toner containing portion 704 and the exterior member 705 can be formed separately and then joined to each other. The method of joining is not particularly limited, and examples of the method of joining include adhesion using an adhesive, ultrasonic fusion, and mechanical connection using snap fit. Thus, the waste-toner container 700 may be a container provided with the exterior member 705 (second exterior member), and the exterior member 705 can be molded integrally with the waste-toner containing portion 704 or can be a member provided separately from the waste-toner containing portion 704.

Here, the process cartridge B and the toner cartridge C are replaced with a relatively high frequency on account of, for example, jam processing or cartridge life service. On the other hand, since the amount of emergence of waste toner is smaller than the amount of consumption of toner for the time of image formation, the frequency of replacement of the waste-toner container 700 is low.

The mounting and demounting directions N, in which the waste-toner container 700 is attached to and detached from the apparatus main body 1A, intersect with the mounting and demounting directions J of the process cartridge B and the toner cartridge C. Setting the mounting and demounting directions N as directions intersecting with the mounting and demounting directions J enables making the directions for performing the replacement operation of the waste-toner container 700, which is relatively low in the frequency of replacement, and the directions for performing the replacement operation of the process cartridge B and the toner cartridge C, which is relatively high in the frequency of replacement, different from each other. Therefore, it is possible to reduce an erroneous operation to be performed by the user and an operation load to be imposed on the user.

For example, it is possible to reduce the possibility that, at the time of replacement of the process cartridge B or the toner cartridge C, the user performs mounting or demounting of the waste-toner container 700 by mistake or the user carelessly comes into contact with the waste-toner container 700, thus causing scatter of waste toner.

In the first embodiment, the mounting and demounting directions N, in which the waste-toner container 700 is attached to and detached from the apparatus main body 1A, can be parallel to the direction of the rotational axis E of the photosensitive drum 11.

Moreover, while the waste-toner container 700 is arranged at the right-side surface of the apparatus main body 1A, the rotational shaft F of the front door 600 is located at the left-side end portion of the apparatus main body 1A, which is the side opposite to the waste-toner container 700 as viewed in the leftward and rightward directions (Y-axis direction). In this configuration, in response to the user opening the front door 600 in the rotation directions H around the rotational shaft F, the front door 600 moves in a direction to move away from the waste-toner container 700.

For example, consider a case where the rotational shaft F of the front door 600 is located at the right-side end portion of the apparatus main body 1A. In this case, in response to the front door 600 being opened, the front door 600 is interposed between a first working area for attaching and detaching the process cartridge B and the toner cartridge C in the mounting and demounting directions J and a second working area for attaching and detaching the waste-toner container 700 in the mounting and demounting directions N. Therefore, for example, in the case of concurrently performing the replacement of the waste-toner container 700 and the replacement of the process cartridge B or the toner cartridge C, a state in which the front door 600 has projected between the first working area and the second working area appears, so that an operation to be performed by the user may be hindered. On the other hand, according to the first embodiment, since, in response to the front door 600 being opened, the front door 600 moves in a direction to move away from the waste-toner container 700, it is possible to attain an improvement in workability for cartridge replacement.

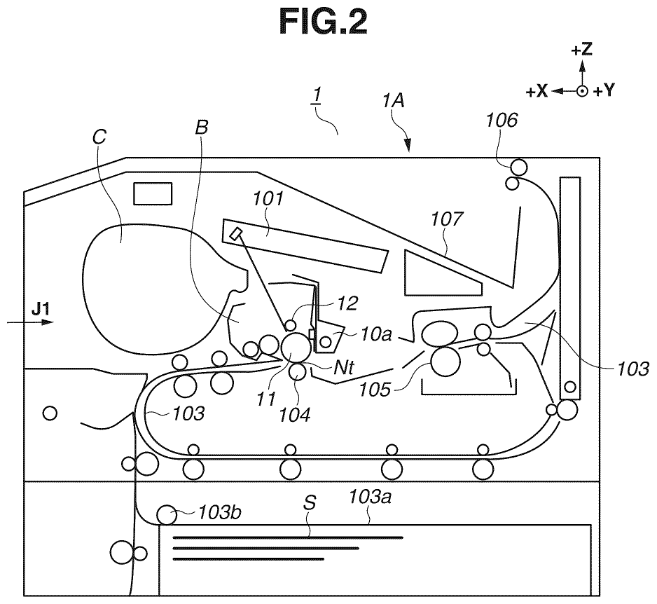

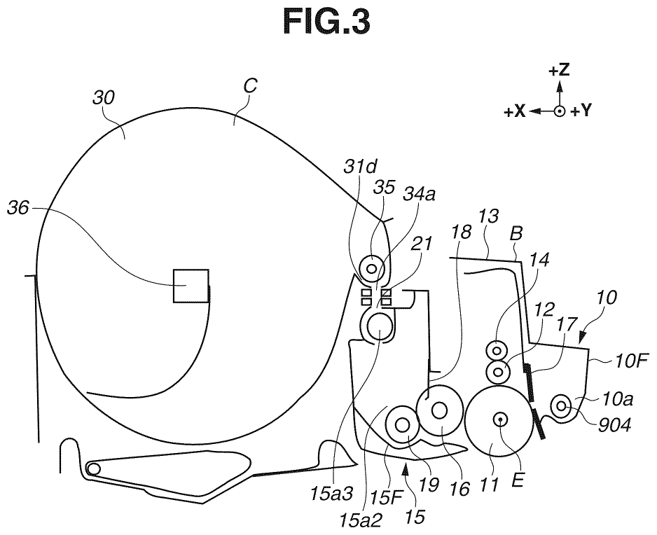

Next, the apparatus main body 1A, the process cartridge B, and the toner cartridge C are described with reference to FIG. 2 and FIG. 3. FIG. 2 is a sectional view of the image forming apparatus 1 according to the first embodiment. FIG. 3 is a sectional view of the process cartridge B and the toner cartridge C according to the first embodiment.

### <Apparatus Main Body>

As illustrated in FIG. 2, the apparatus main body 1A includes a cassette 103a, a feeding roller 103b, a sheet conveyance path 103, a laser scanner 101, a transfer roller 104, a fixing unit 105, a discharge roller pair 106, and a discharge tray 107. These members are supported by the main body housing 1A1.

The cassette 103a is a sheet containing portion in which sheets S serving as a recording material (recording medium) are stacked and stored. The sheets S to be usable include a variety of sheet materials different in size and material quality, such as paper including, for example, plain paper and heavy paper, a surface-treat sheet material such as coated paper, a specially shaped sheet material such as an envelope or index paper, a plastic film, and cloth. The feeding roller 103b is an example of a feeding member for feeding sheets S. The laser scanner 101 is an exposure unit including a laser oscillator as a light source. Furthermore, the exposure unit to be used can be a light-emitting diode (LED) exposure device including, as a light source, a plurality of LED elements arranged side by side in the direction of the rotational axis E of the photosensitive drum 11.

The transfer roller 104 is a transfer member for transferring an image (toner image) from the photosensitive drum 11 to a sheet S. In a state in which the process cartridge B has been mounted to the apparatus main body 1A, the photosensitive drum 11 is in abutting contact with the transfer roller 104 and forms a transfer portion Nt as a transfer nip portion for transferring a toner image to a sheet S in conjunction with the transfer roller 104. Furthermore, the transfer roller 104 can be included not in the apparatus main body 1A but in the process cartridge B.

The fixing unit 105 is a device which thermally fixes, to a sheet S, a toner image transferred to the sheet S. The fixing unit 105 includes a heating roller which comes into contact with the toner image formed on the sheet S, a pressure roller which comes into pressure contact with the heating roller to form a fixing nip, and a heating unit such as a halogen lamp which heats the heating roller. Instead of the heating roller and the pressure roller, a cylindrical film or a belt suspended by a plurality of rollers in a tensioned manner can be used. Moreover, the heating unit to be used can be, for example, a coil for heating a conductive layer included in the heating roller by induction heating.

The discharge roller pair 106 is a discharge unit which discharges a sheet S from the inside of the main body housing 1A1 to the outside thereof. The discharge tray 107 is a stacking portion on which a sheet S with an image formed thereon is stacked. The discharge tray 107 in the first embodiment is a part of the upper surface portion of the main body housing 1A1.

The sheet conveyance path 103 is a conveyance path for a sheet S which is conveyed from the feeding roller 103b to the discharge roller pair 106 via the transfer portion Nt and the fixing nip portion. The apparatus main body 1A includes a plurality of conveyance guides which forms the sheet conveyance path 103. A part of the sheet conveyance path 103 can be formed by a conveyance guide surface provided in the process cartridge B.

### <Process Cartridge>

As illustrated in FIG. 3, the process cartridge B in the first embodiment includes a cleaning unit 10 (a photosensitive drum unit or a latent image unit) and a development unit 15.

The cleaning unit 10 includes the photosensitive drum 11, a charging roller 12, a charging cleaner 14, a cleaning blade 17, and a cleaning housing 10F.

The photosensitive drum 11 rotates around the rotational axis E (FIG. 3), which extends in the Y-axis direction (second direction) intersecting with both the mounting and demounting directions J of the process cartridge B and the direction of gravitational force. The photosensitive drum 11 is, for example, an electrophotographic photosensitive member with a photosensitive layer formed at the outer circumference portion of a cylindrical conductive base material formed from, for example, aluminum. The photosensitive drum 11 functions as an image bearing member which bears a latent image and a developer image (toner image). The photosensitive drum 11 is rotationally driven by drive force of a drive source (motor) arranged in the apparatus main body 1A.

The charging roller 12 is arranged to be in contact with the outer circumferential surface of the photosensitive drum 11. The charging roller 12 is an example of a charger which electrically charges the photosensitive drum 11, and can be, for example, a charger which electrically charges the photosensitive drum 11 by corona discharge. The charging roller 12 is configured to rotate while following the photosensitive drum 11.

The charging cleaner 14 is a roller which is arranged in such a way as to be in abutting contact with the surface (outer circumferential surface) of the charging roller 12. The charging cleaner 14 is configured to clean the surface of the charging roller 12 while rotating following the charging roller 12.

The cleaning housing 10F is a housing of the cleaning unit 10. The photosensitive drum 11, the charging roller 12, and the charging cleaner 14 are supported by the cleaning housing 10F in such a way as to be rotatable, and rotate around the respective rotational axes thereof extending in the Y-axis direction. Inside the cleaning housing 10F, a waste-toner temporarily containing portion 10a, which is a space for temporarily containing waste toner removed from the photosensitive drum 11 by the cleaning blade 17, is formed.

The cleaning blade 17 is a blade which comes into abutting contact with the surface (outer circumferential surface) of the photosensitive drum 11 and which scrapes an adhered material, such as transfer residual toner (residual toner) having remained on the surface of the photosensitive drum 11 without being transferred to a sheet S at the transfer portion Nt. Hereinafter, an adhered material such as residual toner removed from the photosensitive drum 11 by the cleaning blade 17 is collectively referred to as “waste toner”.

The cleaning blade 17 has elasticity, and includes a base portion which is supported by the cleaning housing 10F and a front edge which is in pressure contact with the photosensitive drum 11. The abutting contact direction of the cleaning blade 17 can be a direction in which the front edge thereof faces the upstream side in the rotation direction of the photosensitive drum 11 (a counter direction) or can be a direction in which the front edge thereof faces the downstream side in the rotation direction of the photosensitive drum 11 (trailing direction or with direction). Moreover, the cleaning blade 17 is an example of a cleaning member, and, for example, a roller or brush which is arranged in such way as to come into contact with the surface of the photosensitive drum 11 can also be used as the cleaning member.

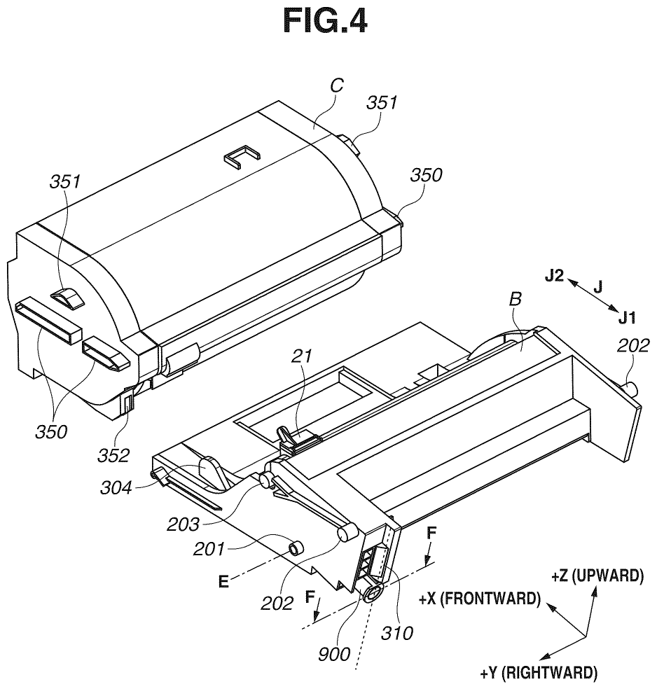

Moreover, the cleaning unit 10 includes a first waste-toner conveyance portion 900 (FIG. 4), which conveys waste toner from the waste-toner temporarily containing portion 10a toward the waste-toner container 700. The details of the first waste-toner conveyance portion 900 are described below.

The development unit 15 includes a development roller 16, a supply roller 19, a development blade 18, and a development housing 15F.

The development housing 15F is a housing of the development unit 15. The development roller 16 and the supply roller 19 are supported by the development housing 15F in such a way as to be rotatable. Inside the development housing 15F, a toner containing portion 15a2, which contains toner as a developer, and a toner receiving chamber 15a3, which receives toner from the toner cartridge C, are formed. The toner receiving chamber 15a3 and the toner containing portion 15a2 communicate with each other. The toner containing portion 15a2 is configured to contain toner to be borne by the development roller 16 and receive toner supplied from the toner cartridge C (toner container). Moreover, a resupply port 21 which passes through from the outer surface of the development housing 15F to the toner receiving chamber 15a3 is formed in the development housing 15F.

To develop a latent image formed on the photosensitive drum 11 into a toner image, the development roller 16 supplies, to the photosensitive drum 11, toner which is contained in the toner containing portion 15a2. The supply roller 19 supplies (applies), to the development roller 16, toner contained in the toner containing portion 15a2.

The development blade 18 is arranged in such a way as to be in abutting contact with the surface of the development roller 16, and regulates the amount of toner (toner layer thickness) which arrives at opposite portions of the development roller 16 and the photosensitive drum 11 while being borne on the surface of the development roller 16. Thus, the development blade 18 is an adjustment unit for adjusting the supply quantity of toner. Moreover, the development blade 18 rubs toner on the development roller 16 and thus imparts, to toner, an electric charge with a normal polarity of toner.

Furthermore, the process cartridge B is configured in such a manner that the toner remaining amount in the toner containing portion 15a2 is detected by a remaining-amount detection unit. The remaining-amount detection unit can be, for example, an optical sensor including a sensor substrate which includes a light emitting element and a light receiving element and is attached to the process cartridge B and a light guiding member which guides light emitted by the light emitting element to the light receiving element via an optical path passing through the inside of the toner containing portion 15a2. A control unit of the image forming apparatus 1 mounted in the apparatus main body 1A acquires the toner remaining amount in the toner containing portion 15a2 based on a result of detection performed by the remaining-amount detection unit, and, if the toner remaining amount becomes less than or equal to a predetermined threshold value, the control unit performs a resupply operation for toner using the toner cartridge C. Toner discharged from the toner cartridge C by the resupply operation falls into the toner receiving chamber 15a3 via the resupply port 21, and is then conveyed to the toner containing portion 15a2 by a conveyance member included in the toner receiving chamber 15a3.

### <Toner Cartridge>

The toner cartridge C includes a resupply toner containing portion 30, a toner discharge port 34a, a discharge screw 35, and an agitating conveyance unit 36.

The resupply toner containing portion 30 forms a storage space in which toner to be supplied to the process cartridge B is contained. The toner discharge port 34a is an opening which communicates with the resupply toner containing portion 30 from the outside of the toner cartridge C. The discharge screw 35 is a conveyance member which conveys toner toward the toner discharge port 34a. The agitating conveyance unit 36 is arranged in the resupply toner containing portion 30, and agitates toner contained in the resupply toner containing portion 30 and conveys the toner toward the discharge screw 35.

A portion of the resupply toner containing portion 30 corresponding to the discharge screw 35 is provided with a curvature-shaped portion 31d with a curvature shape along a rotational trajectory of the blade front edge of the discharge screw 35. The toner discharge port 34a is provided at a lower portion of the curvature-shaped portion 31d.

In a state in which the process cartridge B and the toner cartridge C have been mounted to the apparatus main body 1A, the toner discharge port 34a of the toner cartridge C and the resupply port 21 of the process cartridge B communicate with each other in the state of being insulated from the outside to prevent toner from leaking out. With this configuration, toner discharged from the toner discharge port 34a is supplied to the toner containing portion 15a2 via the resupply port 21 and the toner receiving chamber 15a3 of the process cartridge B. The agitating conveyance unit 36 of the toner cartridge C is rotationally driven by drive force of a drive source (motor) arranged in the apparatus main body 1A.

### <Image Forming Operation>

Next, an image forming operation which the image forming apparatus 1 performs is described with reference to FIG. 2. The image forming operation is a series of operations in which the image forming apparatus 1 forms an image on a sheet S while conveying sheets S one by one and then discharges the sheet S as a printed product.

For example, when having received image information from an external computer, the control unit of the image forming apparatus 1 starts execution of the image forming operation. In response to the image forming operation being started, the photosensitive drum 11 is rotationally driven and the charging roller 12 uniformly performs charging processing on the surface of the photosensitive drum 11 up to a predetermined electric potential.

The laser scanner 101 is driven by a video signal which the control unit generates based on the image information and performs exposure by radiating laser light to the photosensitive drum 11. With this exposure, an electrostatic latent image corresponding to the image information is formed on the surface of the photosensitive drum 11. The development roller 16, bearing toner thereon, supplies the toner to the photosensitive drum 11 and thus develops the electrostatic latent image into a toner image.

In parallel with the formation of a toner image on the photosensitive drum 11, a sheet S is conveyed from the cassette 103a toward the transfer portion Nt. Specifically, the feeding roller 103b rotates while coming into abutting contact with the uppermost sheet S in the cassette 103a and thus feeds the sheet S. The sheet S which has been fed is subjected to skew correction and timing adjustment by the sheet conveyance path 103 and is then conveyed toward the transfer portion Nt.

Then, due to the application of a transfer voltage to the transfer roller 104, when the sheet S passes through the transfer portion Nt, the toner image is transferred from the photosensitive drum 11 to the sheet S.

The sheet S which has passed through the transfer portion Nt is subjected to image fixing processing by the fixing unit 105. The fixing unit 105 heats and presses the toner image on the sheet S while nipping and conveying the sheet S at the fixing nip, thus fixing the toner image to the sheet S. The sheet S which has passed through the fixing unit 105 is conveyed to the discharge roller pair 106 via the sheet conveyance path 103, is discharged by the discharge roller pair 106, and is then stacked on the discharge tray 107.

### <Mounting and Demounting of Process Cartridge and Toner Cartridge>

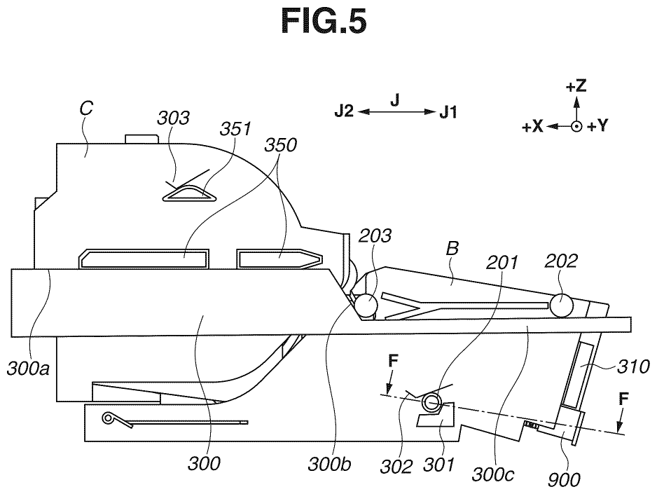

Next, procedures for mounting and demounting the process cartridge B and the toner cartridge C to and from the apparatus main body 1A are described with reference to FIGS. 4 and 5. FIG. 4 is a perspective view of the process cartridge B and the toner cartridge C. FIG. 5 is an explanatory diagram used to explain a state in which the process cartridge B and the toner cartridge C have been completely mounted to the apparatus main body 1A. FIG. 5 illustrates a condition of guide members (300a to 300c), which are parts of the apparatus main body 1A, and the process cartridge B and the toner cartridge C as viewed in the Y-axis direction.

As illustrated in FIGS. 4 and 5, the side walls in the longitudinal direction of the process cartridge B (direction of the rotational axis E of the photosensitive drum 11) are provided with first guided portions 202 and second guided portions 203. The first guided portions 202 and second guided portions 203 are, for example, cylindrical projections (bosses). With regard to the mounting direction J1 of the process cartridge B, the first guided portions 202 are arranged on the more downstream side than the second guided portions 203. Moreover, the side walls of the process cartridge B are provided with drum shafts 201. The drum shafts 201 are cylindrical projections provided on the rotational axis E of the photosensitive drum 11.

In the apparatus main body 1A, as illustrated in FIG. 5, guide members 300 (guide rails) which guide the process cartridge B and the toner cartridge C are arranged. While, in FIG. 5, only the near-side guide member 300 is illustrated as viewed in the Y-axis direction, the guide members 300 are arranged at both sides in the Y-axis direction with respect to the mounting space G (FIG. 1A) for the process cartridge B and the toner cartridge C. The guide member 300 on one side illustrated in FIG. 5 and the guide member 300 on the other side in the Y-axis direction can be the same in shape. Moreover, the first guided portions 202, the second guided portions 203, and the drum shafts 201 are provided at the side walls on both sides in the longitudinal direction of the process cartridge B.

Each of the guide members 300 extends along the mounting and demounting directions J of the process cartridge B and the toner cartridge C. Each of the guide members 300 includes, in order from the upstream side to the downstream side in the mounting direction J1, a first guide portion 300a, a second guide portion 300b, and a third guide portion 300c.

The first guide portion 300a extends approximately in parallel to the X-axis direction. The second guide portion 300b is slanted downward toward the mounting direction J1. The third guide portion 300c extends approximately in parallel to the X-axis direction below the first guide portion 300a.

In the course of the process cartridge B being mounted into the mounting space G (FIG. 1A) in the apparatus main body 1A, the first guided portions 202 and second guided portions 203 are guided by the guide members 300. First, the first guided portions 202 engage with the first guide portions 300a of the guide members 300 and are then guided by the first guide portions 300a. When the process cartridge B is further inserted toward the mounting direction J1, the second guided portions 203 engage with the first guide portions 300a and are then guided by the first guide portions 300a. Moreover, the first guided portions 202 move downward along the slant of the second guide portions 300b and move in the mounting direction J1 along the third guide portions 300c.

Moreover, the apparatus main body 1A includes a positioning portions 301, which are arranged to engage with the drum shafts 201, and urging members 302, which are arranged to urge the drum shafts 201. In response to the process cartridge B being mounted to the apparatus main body 1A along the guide members 300, the drum shafts 201 engage with the positioning portions 301. Due to the engagement of the drum shafts 201 and the positioning portions 301, the position of the rotational axis E of the photosensitive drum 11 relative to the apparatus main body 1A is determined. Moreover, the urging members 302 urge the drum shafts 201 in such a way as to press the drum shafts 201 to the positioning portions 301.

The position of the process cartridge B in which the drum shaft 201 engages with the positioning portions 301 is referred to as a “mounting completion position” of the process cartridge B. The mounting completion position is the position of the process cartridge B obtained when the image forming apparatus 1 performs an image forming operation using the process cartridge B.

In the state in which the process cartridge B is in the mounting completion position, in the process cartridge B, the first guided portions 202 face the third guide portions 300c and the second guided portions 203 face the second guide portions 300b. In response to driving being input to the photosensitive drum 11 in the state in which the process cartridge B is in the mounting completion position, due to the second guided portions 203 being in abutting contact with the second guide portions 300b, turning of the process cartridge B around the rotational axis E is restricted. At that time, a clearance gap is formed between the first guided portions 202 and the third guide portions 300c.

Next, a configuration for guiding mounting and demounting of the toner cartridge C is described. As illustrated in FIG. 4, the side walls on both sides in the longitudinal direction of the toner cartridge C (direction of the rotational axis E of the photosensitive drum 11) are provided with third guided portions 350 and projection portions 351. The third guided portions 350 are projections extending along the mounting and demounting directions J of the toner cartridge C.

In the course of the toner cartridge C being mounted into the mounting space G (FIG. 1A) in the apparatus main body 1A, the third guided portions 350 are guided by the first guide portions 300a of the guide members 300. The toner cartridge C is inserted in the mounting direction J1 up to a position in which the toner discharge port 34a (FIG. 3) faces the resupply port 21 of the process cartridge B.

Moreover, the apparatus main body 1A includes urging members 303 which are arranged to urge the projection portions 351 of the toner cartridge C. In response to the toner cartridge C being mounted to the apparatus main body 1A along the guide members 300, the urging members 303 come into contact with the projection portions 351. Moreover, the urging members 303 urge the toner cartridge C in such a way as to press the third guided portions 350 to the first guide portions 300a of the guide members 300. Due to this urging force, the movement of the toner cartridge C in a direction in which the toner discharge port 34a moves away from the resupply port 21 is restricted.

Moreover, as illustrated in FIG. 4, the process cartridge B is provided with a rib 304 which extends in a direction intersecting with the direction of the rotational axis E of the photosensitive drum 11, and the toner cartridge C is provided with a groove portion 352 formed in such a way as to be able to receive the rib 304. In response to the rib 304 engaging with the groove portion 352 at the time of mounting the toner cartridge C to the apparatus main body 1A, the position of the toner cartridge C relative to the process cartridge B is determined with respect to the longitudinal direction (direction of the rotational axis E of the photosensitive drum 11). This enables increasing the positioning accuracy of the toner discharge port 34a and the resupply port 21 in the longitudinal direction and thus enables reducing toner leakage.

As described above, the toner cartridge C (toner container) mounted to the apparatus main body 1A is positioned relative to the apparatus main body 1A with regard to the mounting and demounting directions J (first direction) and the direction of gravitational force. On the other hand, the toner cartridge C (toner container) mounted to the apparatus main body 1A is positioned relative to the process cartridge B with regard to the direction of the rotational axis E of the photosensitive drum 11 (second direction). Therefore, it is possible to reduce toner leakage occurring in the portions (34a and 21) used for transfer of toner from the toner cartridge C (toner container) to the process cartridge B (cartridge).

### <Contact Configuration>

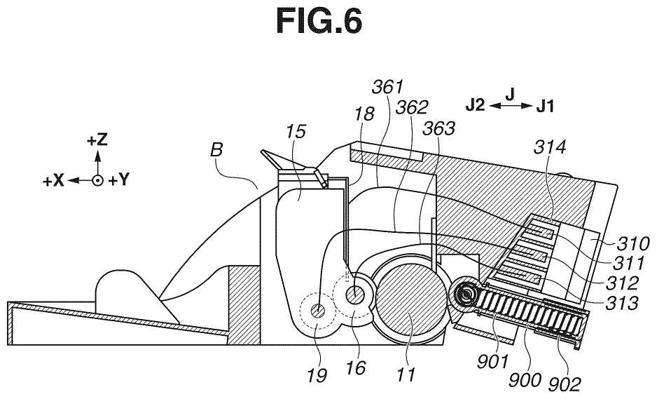

Next, a configuration concerning electric contacts of the process cartridge B and the apparatus main body 1A and a configuration for conveying waste toner from the process cartridge B to the apparatus main body 1A are described with reference to FIG. 6 to FIGS. 8A and 8B.

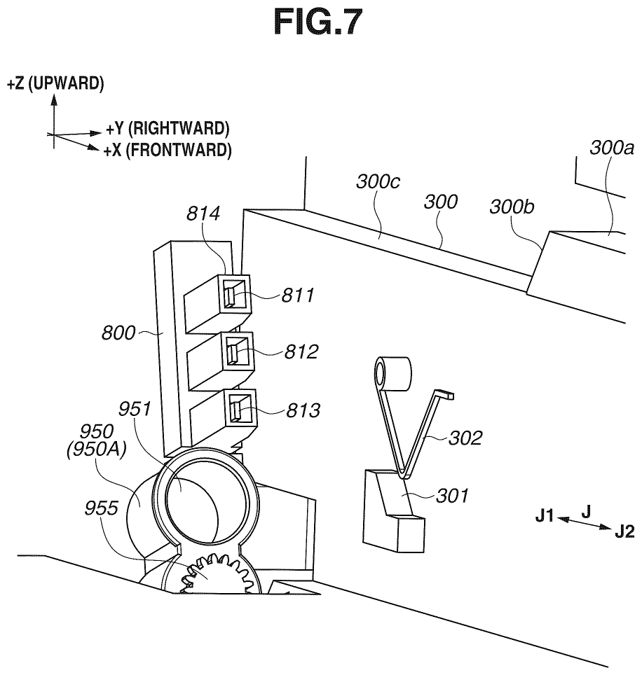

FIG. 6 is a sectional view of the process cartridge B according to the first embodiment and is a diagram used to explain a contact unit 310 and a first waste-toner conveyance portion 900. FIG. 7 is a sectional view illustrating a part of the apparatus main body 1A according to the first embodiment and is a diagram used to explain a main body contact portion 800 and a second waste-toner conveyance portion 950.

As illustrated in FIG. 6, the process cartridge B includes the contact unit 310 (contact portion), which is arranged to receive supplying of electric power from the apparatus main body 1A. The contact unit 310 is arranged at an end portion on the downstream side of the process cartridge B in the mounting direction J1. In other words, the contact unit 310 is arranged on the front edge side in a direction to mount the process cartridge B to the apparatus main body 1A. Moreover, the contact unit 310 is arranged on the side opposite to a drive source of the apparatus main body 1A for driving the photosensitive drum 11 in the direction of the rotational axis E of the photosensitive drum 11 (second direction) (also see FIG. 4).

The contact unit 310 includes a first contact 311, which is electrically connected to the development blade 18, a second contact 312, which is electrically connected to the supply roller 19, and a third contact 313, which is electrically connected to the development roller 16. The contact unit 310 is arranged below the above-mentioned first guided portion 202 (FIG. 5). The first contact 311, the second contact 312, and the third contact 313 are arranged in this order from top to bottom. Furthermore, the alignment sequence of the first contact 311, the second contact 312, and the third contact 313 is not limited to this.

The first contact 311 and the development blade 18 are electrically connected to each other via a wiring 361. The second contact 312 and the supply roller 19 are electrically connected to each other via a wiring 362. The third contact 313 and the development roller 16 are electrically connected to each other via a wiring 363. Furthermore, the illustrated wirings 361 to 363 are schematically represented, and, for example, a conductive resin portion provided in the development housing 15F or cleaning housing 10F can constitute parts of the wirings 361 to 363 serving as conduction paths. Moreover, the contact unit 310 includes a plastic (insulator) rib 314 which surrounds circumferences of the respective contacts as viewed from the downstream side to the upstream side in the mounting direction J1, to assure the creepage distance of each contact and make it difficult for the user to touch each contact.

As illustrated in FIG. 7, the apparatus main body 1A includes a main body contact portion 800 serving as a main body side contact unit. The main body contact portion 800 is a main body side connector portion which is engageable with the contact unit 310 (connector portion) of the process cartridge B.

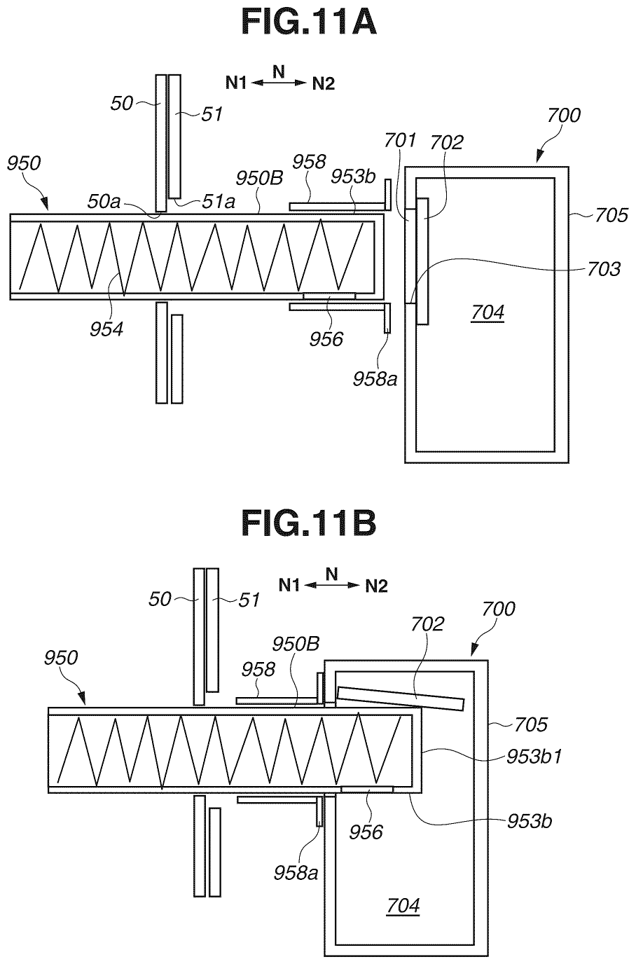

The main body contact portion 800 includes a main body first contact 811, a main body second contact 812, and a main body third contact 813 in such a way as to correspond to the first contact 311, the second contact 312, and the third contact 313, respectively. Each contact of the main body contact portion 800 is electrically connected to an electrical board 51 (FIGS. 11A and 11B) of the apparatus main body 1A. Moreover, the main body contact portion 800 includes a plastic (insulator) engagement guide 814 which surrounds circumferences of the respective contacts as viewed in the mounting direction J1.

In the electrical board 51 (FIGS. 11A and 11B), a plurality of voltage generation circuits which generates a development blade voltage to be applied to the development blade 18, a supply roller voltage to be applied to the supply roller 19, and a development roller voltage (development voltage) to be applied to the development roller 16, respectively, is mounted. The respective voltage generation circuits are capable of supplying predetermined voltages to the development blade 18, the supply roller 19, and the development roller 16 in the state in which the contacts of the contact unit 310 of the process cartridge B are in contact with the contacts of the main body contact portion 800.

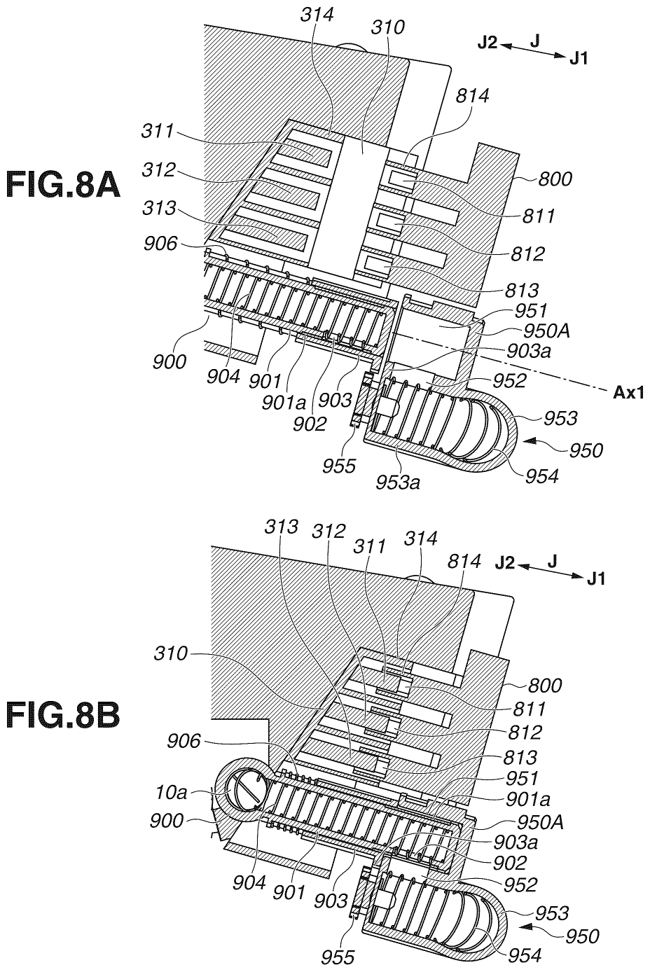

FIGS. 8A and 8B are sectional views illustrating a part of the process cartridge B and a part of the apparatus main body 1A according to the first embodiment, and are diagrams used to explain the engagement of the contact unit 310 and the main body contact portion 800. FIG. 8A represents a condition in which the process cartridge B is in the process of being mounted to the apparatus main body 1A. FIG. 8B represents a condition in which the process cartridge B has been completely mounted to the apparatus main body 1A.

As the process cartridge B is being inserted into the apparatus main body 1A toward the mounting direction J1, as illustrated in FIG. 8A, the contact unit 310, having faced the downstream side in the mounting direction J1, faces the main body contact portion 800, having faced the upstream side in the mounting direction J1. In the state in which the process cartridge B has arrived at the mounting completion position as illustrated in FIG. 8B, the contacts (311, 312, and 313) of the contact unit 310 come into contact with the respective corresponding contacts (811, 812, and 813) of the main body contact portion 800. With this operation, the electrical board 51 of the apparatus main body 1A is electrically connected to the development roller 16, the supply roller 19, and the development blade 18, which are power feeding targets in the process cartridge B.

Moreover, in the process of transitioning from the state illustrated in FIG. 8A to the state illustrated in FIG. 8B, the engagement guide 814 of the main body contact portion 800 engages with the rib 314 of the contact unit 310. With this engagement, the relative positions of the main body contact portion 800 and the contact unit 310 are adjusted in such a manner that the main body contact portion 800 and the contact unit 310 surely come into contact with each other. Furthermore, at least one of the main body contact portion 800 and the contact unit 310 can be configured to be movable in a direction intersecting with the mounting and demounting directions J (be supported in a floating manner).

Here, the positional relationship between the first waste-toner conveyance portion 900 provided in the process cartridge B and the second waste-toner conveyance portion 950 provided in the apparatus main body 1A and the contact unit 310 and the main body contact portion 800 is described.

As illustrated in FIG. 6, the process cartridge B includes the first waste-toner conveyance portion 900 arranged below the contact unit 310. The first waste-toner conveyance portion 900 functions as a first discharge portion which discharges residual toner which the cleaning blade 17 has recovered. The first waste-toner conveyance portion 900 includes a first conveyance pipe 901 having a first discharge port 902 formed therein to discharge waste toner from the process cartridge B.

As illustrated in FIG. 7, the apparatus main body 1A includes the second waste-toner conveyance portion 950 arranged below the main body contact portion 800. The second waste-toner conveyance portion 950 is a conveyance unit which receives waste toner from the process cartridge B and then conveys the waste toner toward the waste-toner container 700. The second waste-toner conveyance portion 950 includes a receiving portion 950A (first receiving portion) which is arranged to receive waste toner from the process cartridge B and a discharge portion 950B (second discharge portion, see FIG. 11B) which is arranged to discharge waste toner toward the waste-toner container 700. The receiving portion 950A includes a receiving port 952. The discharge portion 950B includes a second discharge port 956 (FIG. 11B).

As illustrated in FIGS. 8A and 8B, in the course of the process cartridge B being mounted to the apparatus main body 1A, the first waste-toner conveyance portion 900 engages with the second waste-toner conveyance portion 950. Moreover, in the state in which the process cartridge B has been completely mounted to the apparatus main body 1A, the first discharge port 902 of the first waste-toner conveyance portion 900 communicates with the receiving port 952 of the second waste-toner conveyance portion 950.

Here, a first engagement direction in which the contact unit 310 engages with and disengages from the main body contact portion 800 is approximately parallel to a second engagement direction in which the first waste-toner conveyance portion 900 engages with and disengages from the receiving portion 950A of the second waste-toner conveyance portion 950. Therefore, an operation for mounting the process cartridge B to the apparatus main body 1A enables causing the engagement between the contact unit 310 and the main body contact portion 800 and the engagement between the first waste-toner conveyance portion 900 and the second waste-toner conveyance portion 950 to concurrently progress.

Furthermore, the first engagement direction and the second engagement direction may not be precisely parallel to the mounting and demounting directions J of the process cartridge B. For example, during a period when the process cartridge B moves along the above-mentioned guide members 300, the moving direction of the center of mass of the process cartridge B and the angle of inclination of the process cartridge B relative to the horizontal plane may vary. In this case, it is favorable that, at the timing of whichever comes earlier between when the contact unit 310 begins to engage with the main body contact portion 800 and when the first waste-toner conveyance portion 900 begins to engage with the second waste-toner conveyance portion 950, the moving direction of the downstream end in the mounting direction J1 of the process cartridge B is approximately parallel to the first engagement direction and the second engagement direction.

In the direction of the rotational axis E of the photosensitive drum 11 (second direction), the contact unit 310 (contact portion) and the first waste-toner conveyance portion 900 (first discharge portion) are arranged in an aggregated manner at one end portion of the process cartridge B (FIG. 4). Therefore, it is possible to attain a reduction in size of the process cartridge B. In this case, to minimize the effect of the case where the leakage of waste toner has occurred, it is favorable that the first waste-toner conveyance portion 900 is arranged below the contact unit 310. Moreover, in the direction of the rotational axis E of the photosensitive drum 11, the main body contact portion 800 and the second waste-toner conveyance portion 950 are arranged in an aggregated manner at one end side of the mounting space G. Therefore, it is possible to attain a reduction in size of the apparatus main body 1A.

The contact unit 310, the main body contact portion 800, the first waste-toner conveyance portion 900, and the second waste-toner conveyance portion 950 are arranged on the side opposite to a drive source (motor) which is arranged in the apparatus main body 1A and drives, for example, the photosensitive drum 11. In the first embodiment, the motor serving as a drive source is arranged on the left side of the mounting space G in the apparatus main body 1A (thus, on the side opposite to the right-side surface on which the waste-toner container 700 is located). Moreover, the main body contact portion 800, the first waste-toner conveyance portion 900, and the second waste-toner conveyance portion 950 are arranged on the right side of the center of the apparatus main body 1A in the leftward and rightward directions (thus, on the same side as that of the waste-toner container 700). This enables removing the need for the conveyance path of waste toner going around the drive source and enables shortening the conveyance distance of waste toner from the first waste-toner conveyance portion 900 to the waste-toner container 700.

It is favorable that, as viewed in at least one direction perpendicular to the direction of the rotational axis E of the photosensitive drum 11, the contact unit 310 and the first waste-toner conveyance portion 900 at least partially overlap each other. It is favorable that, as viewed in at least one direction perpendicular to the direction of the rotational axis E of the photosensitive drum 11, the main body contact portion 800 and the second waste-toner conveyance portion 950 at least partially overlap each other.

In the first embodiment, as viewed in the direction of gravitational force, the contact unit 310 and the first waste-toner conveyance portion 900 overlap each other. Moreover, in the first embodiment, as viewed in the direction of gravitational force, the main body contact portion 800 and the second waste-toner conveyance portion 950 overlap each other.

As described above, the first waste-toner conveyance portion 900 and the second waste-toner conveyance portion 950 are arranged below the contact unit 310 and the main body contact portion 800 (in the direction of gravitational force). Therefore, even if waste toner drops when the first waste-toner conveyance portion 900 and the second waste-toner conveyance portion 950 engage with each other, toner is unlikely to adhere to the contact unit 310 and the main body contact portion 800, so that it becomes possible to more stably interconnect the contacts.

While, in the first embodiment, as an example of a contact included in the process cartridge B, the contact unit 310, which includes contacts concerning the development unit 15, has been illustrated, the process cartridge B can include another contact. For example, the contact unit 310 can include a contact for applying a voltage to the charging roller 12 or the charging cleaner 14. Moreover, the contact unit 310 can include a contact for, when attaching a memory tag storing information concerning the process cartridge B (for example, a manufacturer's serial number) to the process cartridge B, electrically interconnecting the memory tag and the control unit of the apparatus main body 1A.

### <First Waste-Toner Conveyance Portion and Second Waste-Toner Conveyance Portion>

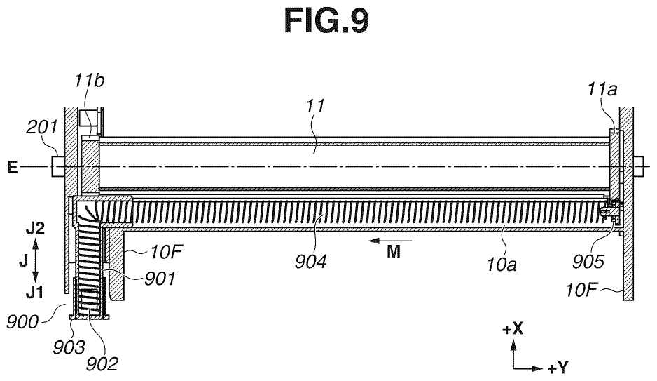

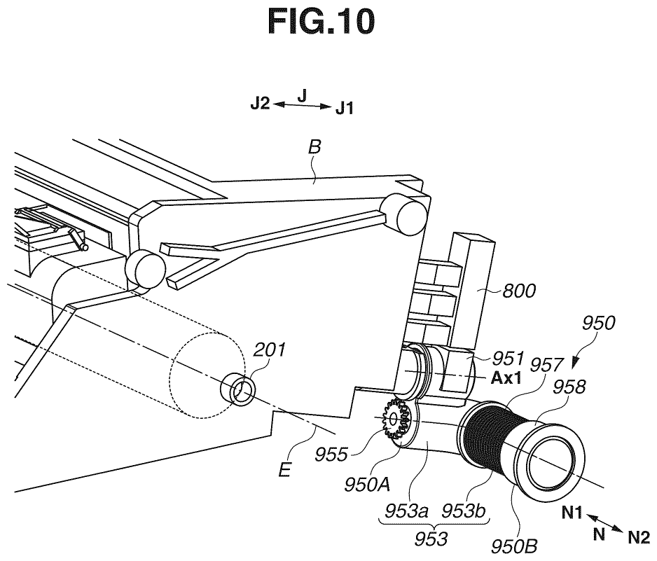

Next, the details of the first waste-toner conveyance portion 900 and the second waste-toner conveyance portion 950 are described with reference to FIG. 4 and FIG. 6 to FIG. 10. FIG. 9 is a sectional view illustrating the insides of the waste-toner temporarily containing portion 10a and the first waste-toner conveyance portion 900 of the process cartridge B and represents a cross-section of the process cartridge B taken along line F-F illustrated in FIG. 4 and FIG. 5. FIG. 10 is a perspective view illustrating the main body contact portion 800 and the second waste-toner conveyance portion 950 of the apparatus main body 1A and a part of the process cartridge B mounted to the apparatus main body 1A.

As illustrated in FIG. 6 and FIGS. 8A and 8B, the first waste-toner conveyance portion 900 includes a first conveyance pipe 901 with a first discharge port 902 formed therein, a first discharge shutter 903, and a first shutter spring 906. As illustrated in FIG. 4, the first waste-toner conveyance portion 900 is arranged at the downstream-side end portion of the process cartridge B in the mounting direction J1.

The first conveyance pipe 901 extends in a direction along the mounting and demounting directions J of the process cartridge B. The upstream end of the first conveyance pipe 901 in the mounting direction J1 communicates with the waste-toner temporarily containing portion 10a, and the downstream end of the first conveyance pipe 901 in the mounting direction J1 is blocked (FIG. 9). The first discharge port 902 is provided near the front edge of the first conveyance pipe 901 in the mounting direction J1 and is open downward in the Z-axis direction.

The first discharge shutter 903 is movable between a closing position for closing the first discharge port 902 and an opening position for opening the first discharge port 902. The first discharge shutter 903 is urged toward the closing position by the first shutter spring 906. In the state obtained before the first waste-toner conveyance portion 900 and the second waste-toner conveyance portion 950 engage with each other, as illustrated in FIG. 8A, the first discharge shutter 903 is in the closing position, thus preventing waste toner from leaking from the first discharge port 902. In the state in which the first waste-toner conveyance portion 900 and the second waste-toner conveyance portion 950 have engaged with each other, as illustrated in FIG. 8B, the first discharge shutter 903 is in the opening position, thus allowing waste toner to be discharged through the first discharge port 902.

As illustrated in FIG. 9, inside the first conveyance pipe 901 and the waste-toner temporarily containing portion 10a, a first conveyance member 904 for conveying waste toner is arranged. The first conveyance member 904 in the first embodiment is a coil spring and is capable of rotating while being bent along the flection of a connection portion between the first conveyance pipe 901 and the waste-toner temporarily containing portion 10a. Furthermore, a screw can be arranged as the first conveyance member 904 for each of the first conveyance pipe 901 and the waste-toner temporarily containing portion 10a.

One end of the first conveyance member 904 is connected to a first conveyance gear 905 provided at one end portion of the waste-toner temporarily containing portion 10a in the direction of the rotational axis E of the photosensitive drum 11. The first conveyance gear 905 is supported by the cleaning housing 10F in such a way as to be freely rotatable. A sliding portion between the cleaning housing 10F and the first conveyance gear 905 is sealed by a seal member (not illustrated) in such a way as to prevent waste toner from leaking out.

The first conveyance gear 905 is engaged with a first drum gear 11a provided at the end portion of the photosensitive drum 11. The first drum gear 11a rotates by a drive force of the drive source provided in the apparatus main body 1A and thus causes the first conveyance gear 905 to rotate. The first conveyance member 904 rotates in conjunction with the first conveyance gear 905 and is thus capable of conveying waste toner contained in the waste-toner temporarily containing portion 10a in a conveyance direction M which proceeds from one end side to the other end side in the direction of the rotational axis E of the photosensitive drum 11.

The first conveyance pipe 901 includes a first portion which extends in the direction of the rotational axis E of the photosensitive drum 11 and a second portion which extends in a direction intersecting with the direction of the rotational axis E of the photosensitive drum 11 (direction along the mounting and demounting directions J) and thus has a shape bent in an L-shaped manner. The first portion of the first conveyance pipe 901 is embedded in a through-hole formed in the cleaning housing 10F and thus communicates with the waste-toner temporarily containing portion 10a. The first discharge port 902 is formed in the second portion of the first conveyance pipe 901. The first conveyance member 904 rotates while being bent along the bent portion of the first conveyance pipe 901, thus being able to convey waste toner even in the bent portion.

Next, the second waste-toner conveyance portion 950 of the apparatus main body 1A is described. As illustrated in FIGS. 8A and 10, the second waste-toner conveyance portion 950 includes a second engagement portion 951, a second conveyance pipe 953, a second conveyance member 954, a second conveyance gear 955, a second discharge shutter 958, and a second shutter spring 957.

The second engagement portion 951 is a portion which engages with a first engagement portion 901a of the first waste-toner conveyance portion 900. The first engagement portion 901a in the first embodiment is an outer circumferential surface on the front edge side of the first conveyance pipe 901 in the mounting direction J1, and the second engagement portion 951 is a cylindrical recessed portion which receives the outer circumferential surface on the front edge side of the first conveyance pipe 901. Moreover, the engagement direction of the first engagement portion 901a and the second engagement portion 951 in the first embodiment is the direction of a central axis Ax1 of the second engagement portion 951, which is cylindrical. The engagement direction of the first engagement portion 901a and the second engagement portion 951 is a direction along the mounting direction J1 and can be parallel to the mounting direction J1.

The second conveyance pipe 953 is arranged below the second engagement portion 951. At an upper portion of the second conveyance pipe 953, a receiving port 952 is formed. The second conveyance pipe 953 includes a first portion 953a which extends approximately in parallel to the mounting and demounting directions J of the process cartridge B and a second portion 953b (FIG. 10) which is bent in a direction intersecting with the mounting and demounting directions J. The extension direction of the second portion 953b is a direction along the mounting and demounting directions N of the waste-toner container 700.

The second conveyance member 954 is arranged inside the second conveyance pipe 953. The second conveyance member 954 in the first embodiment is a coil spring and is capable of rotating while bending along the bent portion of the second conveyance pipe 953. Furthermore, a screw can be arranged as the second conveyance member 954 for each of the first portion 953a and the second portion 953b of the second conveyance pipe 953.

One end of the second conveyance member 954 is connected to the second conveyance gear 955. The second conveyance gear 955 is arranged outside the second conveyance pipe 953. The second conveyance gear 955 is connected to a second drum gear 11b provided at an end portion opposite to the first drum gear 11a (FIG. 9) of the photosensitive drum 11. Therefore, the second conveyance gear 955 is rotationally driven in conjunction with the rotation of the photosensitive drum 11, and the second conveyance member 954 is rotationally driven in conjunction with the rotation of the second conveyance gear 955.

The second discharge port 956, the second discharge shutter 958, and the second shutter spring 957, which are provided in the second conveyance pipe 953, are described below.

As illustrated in FIGS. 8A and 8B, in response to the process cartridge B being inserted into the apparatus main body 1A toward the mounting direction J1, the first engagement portion 901a of the first waste-toner conveyance portion 900 engages with the second engagement portion 951 of the second waste-toner conveyance portion 950. Thus, the front edge portion (first engagement portion 901a) of the first conveyance pipe 901 enters the recessed portion (second engagement portion 951) of the second waste-toner conveyance portion 950. At that time, the end surface of the opening portion of the second engagement portion 951 facing in the direction opposite to the mounting direction J1 comes into abutting contact with an abutting contact portion 903a, which is an end surface in the mounting direction J1 of the first discharge shutter 903. With this abutting contact, the first discharge shutter 903 slides against the urging force of the first shutter spring 906 and thus moves from the closing position to the opening position.

In response to the first discharge shutter 903 moving to the opening position, the first discharge port 902 becomes exposed. Moreover, in response to the process cartridge B being completely mounted to the apparatus main body 1A, the first discharge port 902 faces the receiving port 952 of the second conveyance pipe 953. With this facing, the first waste-toner conveyance portion 900 and the second waste-toner conveyance portion 950 are interconnected in such a way as to enable waste toner to move from the first conveyance pipe 901 to the second conveyance pipe 953.

The flow of conveyance of waste toner from the process cartridge B to the second waste-toner conveyance portion 950 in the state in which the mounting of the process cartridge B has been completed (FIG. 8B) is described. Waste toner which has been removed from the surface of the photosensitive drum 11 by the cleaning blade 17 (FIG. 3) is caused to be contained in the waste-toner temporarily containing portion 10a of the process cartridge B. The waste toner which has been contained in the waste-toner temporarily containing portion 10a is conveyed in the conveyance direction M, which is along the direction of the rotational axis E of the photosensitive drum 11, by the first conveyance member 904 (FIG. 9). Additionally, the waste toner passes through the bent portion of the first conveyance pipe 901 and is then conveyed in a conveyance direction along the mounting and demounting directions J of the process cartridge B. Then, the waste toner is discharged from the first discharge port 902 of the first conveyance pipe 901, and is then received by the second conveyance pipe 953 through the receiving port 952 of the second waste-toner conveyance portion 950.

According to the above-described configuration, while the contact unit 310 is arranged above the first waste-toner conveyance portion 900, the discharging direction of waste toner from the first discharge port 902 of the first waste-toner conveyance portion 900 (the opening direction of the first discharge port 902) faces downward with respect to the direction of gravitational force. Therefore, it is possible to employ a configuration in which, even if waste toner drops from the first discharge port 902 when the first waste-toner conveyance portion 900 and the second waste-toner conveyance portion 950 engage with each other, the waste toner is unlikely to adhere to the contact unit 310 or the main body contact portion 800. Thus, preventing adhesion of waste toner enables stably connecting the contacts of the contact unit 310 and the contacts of the main body contact portion 800 with each other.

### <Second Waste-Toner Conveyance Portion and Waste-Toner Container>

Next, configurations of the second waste-toner conveyance portion 950 and the waste-toner container 700 are described with reference to FIG. 10 and FIGS. 11A and 11B. FIGS. 11A and 11B are diagrams used to explain the engagement and disengagement of the second waste-toner conveyance portion 950 and the waste-toner container 700. FIGS. 11A and 11B illustrate cross-sections of the second waste-toner conveyance portion 950 and the waste-toner container 700 in a virtual plane extending in the mounting and demounting directions N of the waste-toner container 700 and the Z-axis direction. FIG. 11A represents a condition obtained before the waste-toner container 700 engages with the second waste-toner conveyance portion 950. FIG. 11B represents a condition obtained after the waste-toner container 700 engages with the second waste-toner conveyance portion 950.

As illustrated in FIG. 10, the second waste-toner conveyance portion 950 includes the second portion 953b of the second conveyance pipe 953 serving as a third engagement portion. The second portion 953b of the second conveyance pipe 953 extends toward a direction opposite to the mounting direction N1 of the waste-toner container 700 (demounting direction N2) from the bent portion of the first portion 953a. The front edge portion of the second conveyance pipe 953 in the demounting direction N2 is blocked.

As illustrated in FIGS. 11A and 11B, the second discharge port 956 is formed at the lower portion of the second portion 953b of the second conveyance pipe 953. The second discharge port 956 is open downward in the Z-axis direction.

The second discharge shutter 958 is attached to the outer circumference side of the second conveyance pipe 953 and is movable between a closing position for closing the second discharge port 956 and an opening position for opening the second discharge port 956. The second discharge shutter 958 is urged toward the closed position by the second shutter spring 957. In the state obtained before the second waste-toner conveyance portion 950 and the waste-toner container 700 engage with each other, as illustrated in FIG. 11A, the second discharge shutter 958 is in the closing position, thus preventing waste toner from leaking from the second discharge port 956. In the state in which the second waste-toner conveyance portion 950 and the waste-toner container 700 have engaged with each other, as illustrated in FIG. 11B, the second discharge shutter 958 is in the opening position, thus allowing waste toner to be discharged through the second discharge port 956.

Next, the waste-toner container 700 is described. As illustrated in FIGS. 11A and 11B, the waste-toner container 700 includes the above-mentioned waste-toner containing portion 704 and the exterior member 705, a receiving opening 701, a receiving shutter 702, and a fourth engagement portion 703.

The receiving opening 701 is a through-hole which penetrates from the inside of the waste-toner containing portion 704 to the outside thereof. The receiving opening 701 is open toward the mounting direction N1 of the waste-toner container 700. The receiving opening 701 functions as a receiving portion (second receiving portion) which receives residual toner which is discharged from the discharge portion 950B (second discharge portion) of the second waste-toner conveyance portion 950.

The receiving shutter 702 is movable between a closing position for closing the receiving opening 701 and an opening position for opening the receiving opening 701. The receiving shutter 702 in the first embodiment is supported in such a way as to be able to be turned relative to the waste-toner containing portion 704 in such a manner that the receiving shutter 702 moves from the closing position to the opening position by turning as if falling down toward the demounting direction N2 of the waste-toner container 700. However, the receiving shutter 702 can be supported, for example, in such a way as to be able to slide in the mounting and demounting directions N of the waste-toner container 700.

Moreover, the receiving shutter 702 is urged toward the closing position by an urging member (not illustrated).

The fourth engagement portion 703 is configured to engage with the second portion 953b (third engagement portion) of the second conveyance pipe 953. The fourth engagement portion 703 in the first embodiment is an inner wall of the receiving opening 701.

As illustrated in FIGS. 11A and 11B, in the course of the waste-toner container 700 being mounted to the apparatus main body 1A toward the mounting direction N1, the third engagement portion of the second waste-toner conveyance portion 950 engages with the fourth engagement portion 703 of the waste-toner container 700. Thus, the second portion 953b (third engagement portion) of the second conveyance pipe 953 enters the receiving opening 701 (fourth engagement portion) of the waste-toner container 700. At that time, the end surface of the waste-toner container 700 which is the end surface of a circumferential edge portion of the receiving opening 701 and faces in the mounting direction N1 comes into abutting contact with an abutting contact portion 958a, which is an end surface on a side opposite to that in the mounting direction N1 of the second discharge shutter 958. With this abutting contact, the second discharge shutter 958 slides against the urging force of the second shutter spring 957 and thus moves from the closing position to the opening position. In response to the second discharge shutter 958 moving to the opening position, the second discharge port 956 becomes exposed.

Moreover, when a front edge 953b1 of the second conveyance pipe 953 enters the inside of the waste-toner containing portion 704 through the receiving opening 701 of the waste-toner container 700, the front edge 953b1 presses the receiving shutter 702 to cause the receiving shutter 702 to move from the closing position to the opening position.

In the state in which the mounting of the waste-toner container 700 has been completed as illustrated in FIG. 11B, the second discharge port 956 is opened in an internal space of the waste-toner containing portion 704. With this operation, the second waste-toner conveyance portion 950 and the waste-toner container 700 are interconnected in such a way as to enable the movement of waste toner from the second conveyance 953 to the waste-toner containing portion 704.

The flow of conveyance of waste toner from the second waste-toner conveyance portion 950 to the waste-toner container 700 in the state in which the mounting of the waste-toner container 700 has been completed (FIG. 11B) is described. Waste toner received by the second waste-toner conveyance portion 950 from the first waste-toner conveyance portion 900 is conveyed by the second conveyance member 954 contained in the second conveyance pipe 953. The second conveyance member 954 conveys waste toner through the bent portion of the second conveyance pipe 953 and further conveys the waste toner through the second portion 953b of the second conveyance pipe 953, which is parallel to the mounting and demounting directions N of the waste-toner container 700. Then, the waste toner is discharged from the second discharge port 956 of the second conveyance pipe 953 to the waste-toner containing portion 704 of the waste-toner container 700.

As described above, in response to the process cartridge B and the waste-toner container 700 being mounted to the apparatus main body 1A, a conveyance path from the waste-toner temporarily containing portion 10a of the process cartridge B to the waste-toner containing portion 704 of the waste-toner container 700 becomes continuous. Accordingly, in the state in which the process cartridge B and the waste-toner container 700 have been mounted to the apparatus main body 1A, it is possible to sequentially convey, to the waste-toner containing portion 704, waste toner removed from the photosensitive drum 11 by the cleaning blade 17.

Therefore, it is possible to reduce the volumetric capacity of the waste-toner temporarily containing portion 10a in the process cartridge B. The volumetric capacity of the waste-toner temporarily containing portion 10a included in the process cartridge B can be smaller than the volumetric capacity of the waste-toner containing portion 704 included in the waste-toner container 700. Reducing the volumetric capacity of the waste-toner temporarily containing portion 10a enables attaining a reduction in size of the process cartridge B. Moreover, it is possible to reduce the size of the mounting space G for receiving the process cartridge B. Thus, even if the volumetric capacity of the waste-toner container 700 is increased to reduce the replacement frequency of the waste-toner container 700, it is possible to avoid an increase in size of the process cartridge B and the apparatus main body 1A.

For example, in the first embodiment, at the downstream side of the process cartridge B in the mounting direction J1 of the process cartridge B, the fixing unit 105 is arranged. Therefore, reducing the volumetric capacity of the waste-toner temporarily containing portion 10a enables shortening the distance in the mounting direction J1 from the transfer roller 104, which faces the photosensitive drum 11, to the fixing unit 105. Thus, even if the volumetric capacity of the waste-toner container 700 is increased, it is possible to provide an image forming apparatus 1 in which the distance between the transfer roller 104 and the fixing unit 105 is small.

Moreover, in the first embodiment, at the time of mounting and demounting of the process cartridge B to and from the apparatus main body 1A, the first waste-toner conveyance portion 900 of the process cartridge B engages with and disengages from the receiving portion 950A of the second waste-toner conveyance portion 950, respectively, in directions along the mounting and demounting directions J of the process cartridge B. In other words, at the time of mounting and demounting of the cartridge to and from the apparatus main body, the first discharge portion of the cartridge is configured to engage with and disengage from the first receiving portion, respectively, in directions along the first direction. Moreover, in the first embodiment, at the time of mounting and demounting of the waste-toner container 700 to and from the apparatus main body 1A, the receiving opening 701 of the waste-toner container 700 engages with and disengages from the discharge portion 950B of the second waste-toner conveyance portion 950, respectively, in directions along the mounting and demounting directions N of the waste-toner container 700. In other words, at the time of mounting and demounting of the residual toner container to and from the apparatus main body, the second receiving portion of the residual toner container is configured to engage with and disengage from the second discharge portion, respectively, in directions along the second direction.

With this configuration, by performing a simple operation for moving the process cartridge B in predetermined mounting and demounting directions J, it is possible to cause the first waste-toner conveyance portion 900 and the receiving portion 950A of the second waste-toner conveyance portion 950 to engage with and disengage from each other. Moreover, by performing a simple operation for moving the waste-toner container 700 in predetermined mounting and demounting directions N, it is possible to cause the discharge portion 950B of the second waste-toner conveyance portion 950 and the waste-toner container 700 to engage with and disengage from each other.

<Relationship with Side Plate>

A relationship between the second waste-toner conveyance portion 950 and a right side plate 50 of the apparatus main body 1A is described with reference to FIG. 1A and FIGS. 11A and 11B.

The apparatus main body 1A includes a right side plate 50 (first side plate) and a left side plate 49 (second side plate) having respective surfaces facing in the direction of the rotational axis E of the photosensitive drum 11 (second direction) (FIG. 1A and FIGS. 11A and 11B).

The right side plate 50 is provided at the first end side of the apparatus main body 1A in the direction of the rotational axis E of the photosensitive drum 11 (second direction), and the left side plate 49 is provided at the second end side, which is opposite to the first end side, of the apparatus main body 1A. Then, between the right side plate 50 (first side plate) and the left side plate 49 (second side plate), the mounting space G, in which the process cartridge B (cartridge) is to be mounted, is formed.

The process cartridge B, which includes the first waste-toner conveyance portion 900, is mounted in the mounting space G, which is at the internal side (left side) of the right side plate 50. On the other hand, the waste-toner container 700 is mounted in the opening portion 1Ra (FIG. 1A), which is at the external side (right side) of the right side plate 50. The receiving portion 950A (first receiving portion) of the second waste-toner conveyance portion 950, which engages with the first waste-toner conveyance portion 900, is arranged at the same side as the mounting space G with respect to the right side plate 50. The discharge portion 950B (second discharge portion) of the second waste-toner conveyance portion 950, which engages with the waste-toner container 700, is arranged at the side opposite to the mounting space G with respect to the right side plate 50.

In the first embodiment, in the second waste-toner conveyance portion 950 for conveying waste toner from the first waste-toner conveyance portion 900 to the waste-toner container 700, a penetration portion penetrating the right side plate 50 and available for conveying waste toner is provided. In the right side plate 50, a through-hole 50a penetrating in the leftward and rightward directions (Y-axis direction) is formed. A part of the second portion 953b of the second conveyance pipe 953 is a penetration portion for passing through the through-hole 50a. Thus, the second waste-toner conveyance portion 950 is able to convey waste toner from the internal side of the right side plate 50 (first side plate) to the external side thereof via the second portion 953b of the second conveyance pipe 953 serving as a penetration portion.

Furthermore, the apparatus main body 1A can include a plate-like electrical board 51 which is approximately parallel to the right side plate 50. In this case, in the electrical board 51, a through-hole 51a or a groove formed at a position corresponding to the through-hole 50a of the right side plate 50 can be provided, and the second conveyance pipe 953 can be inserted into the through-hole 51a or the groove. Instead of the through-hole 51a or the groove being provided, two boards arranged at positions excluding the position overlapping the through-hole 50a can be used as the electrical board 51.

### <Arrangement of First Waste-Toner Conveyance Portion>

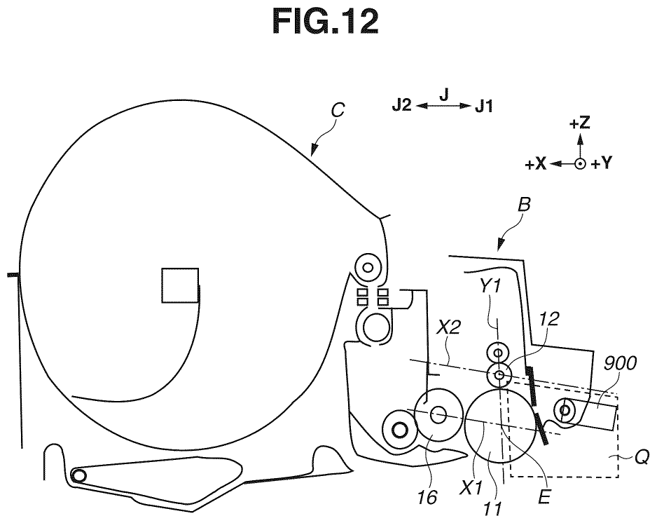

Next, the arrangement of the first waste-toner conveyance portion 900 in the process cartridge B is described with reference to FIG. 12. FIG. 12 is a sectional view illustrating a cross-section of the process cartridge B in the first embodiment taken along a virtual plane perpendicular to the rotational axis E of the photosensitive drum 11.

As viewed in the direction of the rotational axis E of the photosensitive drum 11 (second direction) as illustrated in FIG. 12, a first straight line Y1, a second straight line X1, and a third straight line X2 are defined as follows. A virtual straight line which passes through the rotational axis of the charging roller 12 and the rotational axis E of the photosensitive drum 11 is defined as the first straight line Y1. A virtual straight line which passes through the rotational axis of the development roller 16 and the rotational axis E of the photosensitive drum 11 is defined as the second straight line X1. A virtual straight line which is parallel to the second straight line X1 and passes through the rotational axis of the charging roller 12 is defined as the third straight line X2. The direction of the first straight line Y1 intersects with at least the mounting and demounting directions J (first direction) of the process cartridge B with respect to the apparatus main body 1A. Moreover, the direction of the third straight line X2 intersects with at least the direction of gravitational force (Z-axis direction).

In this case, it is favorable that at least a part of the first waste-toner conveyance portion 900 is arranged in a lower-right area Q defined by the first straight line Y1 and the third straight line X2. The area Q is an area on the downstream side in the mounting direction J1 of the process cartridge B in the mounting and demounting directions J (first direction) with respect to the first straight line Y1 and on the lower side with respect to the third straight line X2.

The above-described arrangement enables the first waste-toner conveyance portion 900 and the second waste-toner conveyance portion 950 to engage with each other without compromising operability in mounting the process cartridge B to the apparatus main body 1A. The above-described arrangement also enables implementing, with a simple configuration, a conveyance path for waste toner from the process cartridge B to the apparatus main body 1A. Moreover, the above-described arrangement also enables reducing the effect of waste toner leakage or waste toner scattering.

If the first waste-toner conveyance portion 900 is arranged at the upstream side in the mounting direction J1 with respect to the first straight line Y1, a configuration in which the movement in the mounting direction J1 of the process cartridge B causes the first waste-toner conveyance portion 900 and the second waste-toner conveyance portion 950 to engage with each other becomes complicated. Moreover, if the entirety of the first waste-toner conveyance portion 900 is arranged at the upstream side in the mounting direction J1 with respect to the first straight line Y1, a configuration for conveying waste toner in a direction opposite to the mounting direction J1 from the cleaning unit 10 to the first waste-toner conveyance portion 900 may be desired. Therefore, a conveyance path for waste toner becomes complicated, thus leading to an increase in size of the process cartridge B or an increase in the number of parts.

Moreover, if the first waste-toner conveyance portion 900 is arranged above the third straight line X2, the effect which occurs when waste toner has leaked out at the time of the engagement of the first waste-toner conveyance portion 900 and the second waste-toner conveyance portion 950 with each other may become large. Thus, it may be considered that waste toner which has leaked out adheres to parts of the apparatus main body 1A or the process cartridge B located below the first waste-toner conveyance 900 and thus causes image failure or contamination of a sheet S.

The arrangement employed in the first embodiment enables avoiding the above-mentioned inconvenience and thus enables providing a process cartridge B or an image forming apparatus 1 excellent in handling of waste toner.

### <Waste-Toner Container>

Next, the waste-toner container 700 is described with reference to FIGS. 13A and 13B. FIGS. 13A and 13B are perspective views each illustrating an outer appearance of the waste-toner container 700. As mentioned above, the exterior member 705 of the waste-toner container 700 constitutes an outer appearance surface of the image forming apparatus 1 in conjunction with the exterior of the apparatus main body 1A.

The grip portion 706 of the waste-toner container 700 is a recessed portion formed in the exterior member 705. Therefore, when the user replaces the waste-toner container 700, the waste-toner containing portion 704 is able to be detached from the apparatus main body 1A together with the exterior member 705, so that it is possible to attain an improvement in usability.

### Second Embodiment

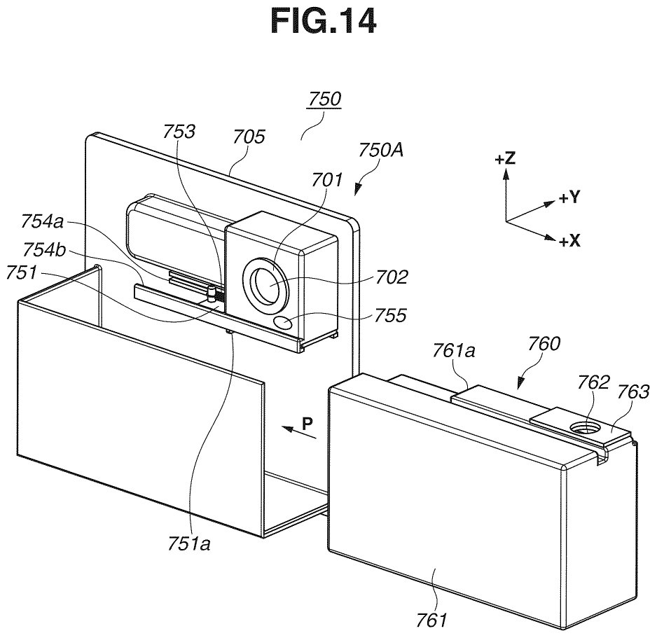

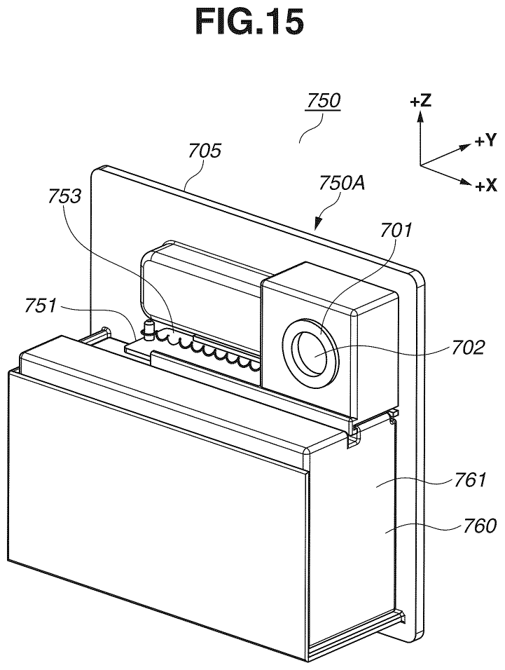

Next, a waste-toner container 750 according to a second embodiment obtained by changing a part of the above-described embodiment is described with reference to FIGS. 14 and 15. FIG. 14 is a perspective view illustrating a state in which a container unit 760 has been detached from an exterior unit 750A of the waste-toner container 750 according to the second embodiment. FIG. 15 is a perspective view illustrating a state in which the container unit 760 has been mounted to the exterior unit 750A according to the second embodiment. In the following description, elements assigned with the respective reference characters in common with those in the above-described first embodiment are assumed to have the basically same configurations and functions as those described in the first embodiment unless otherwise described, and portions different from those in the above-described first embodiment are mainly described.

As illustrated in FIG. 14, the waste-toner container 750 according to the second embodiment includes the exterior unit 750A and the container unit 760, which is attachable to and detachable from the exterior unit 750A.

The exterior unit 750A includes an exterior member 705 (second exterior member), a receiving opening 701, a receiving shutter 702, an intermediate discharge port 755, an intermediate shutter 751, and a shutter spring 753.

The intermediate discharge port 755 is provided below the receiving opening 701 and is open downward. The intermediate shutter 751 is movable between a closing position for closing the intermediate discharge port 755 and an opening position for opening the intermediate discharge port 755, and is urged toward the closed position by the shutter spring 753. Moreover, the exterior unit 750A further includes guide portions 754a and 754b which guide the intermediate shutter 751.

The container unit 760 includes a container main body 761, which contains waste toner, an intermediate receiving port 762, and a seal member 763. The container unit 760 is a residual toner containing portion which is attachable to and detachable from a portion of the waste-toner container 750 with the exterior member 705 (second exterior member) attached thereto.

In response to the container unit 760 being mounted to the exterior unit 750A toward an arrow P direction, an abutting contact surface 761a of the container main body 761 comes into abutting contact with a projection portion 751a of the intermediate shutter 751, so that the intermediate shutter 751 is opened. The arrow P direction is a direction intersecting with the mounting and demounting directions N of the waste-toner container 750. Moreover, as viewed in the mounting and demounting directions N, the exterior unit 750A covers, from outside, the entirety of the container main body 761 mounted to the exterior unit 750A.

In response to the container unit 760 being completely mounted to the exterior unit 750A as illustrated in FIG. 15, the intermediate discharge port 755 and the intermediate receiving port 762 communicate with each other. The seal member 763 seals a clearance gap between the intermediate discharge port 755 and the intermediate receiving port 762, thus preventing the leakage of waste toner. In response to the intermediate discharge port 755 and the intermediate receiving port 762 communicating with each other, waste toner which has been received from the second waste-toner conveyance portion 950 of the apparatus main body 1A through the receiving opening 701 becomes able to move to the inside of the container main body 761 of the container unit 760.

As described above, since the exterior unit 750A of the waste-toner container 750 and the container unit 760 are provided separately from each other, it becomes possible to replace only the container unit 760 if the container unit 760 has become full of waste toner. The exterior unit 750A is usable even after the container unit 760 is replaced. Therefore, it is possible to make a replacement range smaller than that in the first embodiment in which the exterior member 705 of the waste-toner container 700 is also replaced together with the waste-toner containing portion 704.

### Other Embodiments

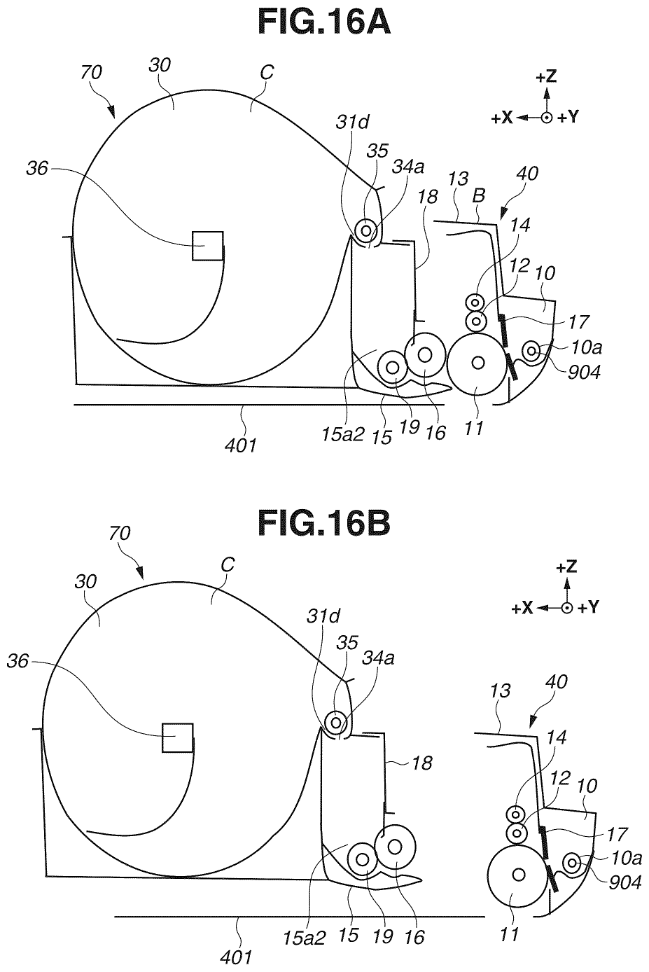

In the above-described embodiments, an example in which the process cartridge B serving as a cartridge includes the photosensitive drum 11, the development roller 16, and the toner containing portion 15a2, which supplies toner to the development roller 16, has been described. The present disclosure is not limited to this, and, as illustrated in FIGS. 16A and 16B, a cartridge (drum cartridge 40) which includes the photosensitive drum 11 but includes neither a development roller nor a toner containing portion and a toner container (development cartridge 70) which includes the development roller 16 and the toner containing portion 15a2 can also be used. Thus, the cleaning unit 10 in the above-described embodiments can be configured as a cartridge (drum cartridge 40) which is attachable to and detachable from the apparatus main body 1A independently from the development unit 15.

In FIGS. 16A and 16B, elements assigned with the respective reference characters in common with those in the above-described first embodiment are assumed to have the basically same configurations and functions as those described in the first embodiment unless otherwise described, and are, therefore, omitted from description here.

As illustrated in FIGS. 16A and 16B, the drum cartridge 40 includes a development cartridge supporting portion 401 (development cartridge mounting portion). FIG. 16A is a diagram illustrating a state in which the development cartridge 70 (toner container) has been mounted to the drum cartridge 40, and FIG. 16B is a diagram illustrating a state in which the development cartridge 70 (toner container) has been demounted from the drum cartridge 40. The development cartridge 70 is attachable to and detachable from the apparatus main body 1A while being in the state of being mounted to the drum cartridge 40. The drum cartridge 40 with the development cartridge 70 mounted thereto can be referred to as a “process cartridge B”. Furthermore, a portion corresponding to the toner cartridge C (a unit which contains toner to be supplied to the toner containing portion 15a2) can be formed as a part of the development cartridge 70. The transfer roller 104 can be included not in the apparatus main body 1A but in the drum cartridge 40.

The waste-toner container (residual toner container) in each of the above-described embodiments is attachable to and detachable from the apparatus main body 1A independently from the drum cartridge 40 and the development cartridge 70. Furthermore, the detailed configuration of the waste-toner container (residual toner container) in a modification example illustrated in FIGS. 16A and 16B can be similar to that in each of the above-described embodiments.

In the present modification example, the contact unit 310 (see FIG. 5 to FIG. 8B) serving as a contact portion may be provided in at least one of the drum cartridge 40 and the development cartridge 70. For example, the contact unit 310 can be provided in the development cartridge 70 and can be connectable to the main body contact portion 800 through an opening (for example, a hole or cutout) provided in the drum cartridge 40. Instead of this, for example, the contact unit 310 can be provided in the drum cartridge 40. In this case, in response to respective relay contacts provided in the drum cartridge 40 and the development cartridge 70 coming into contact with each other, it becomes possible to supply electric power to a power feeding target included in the development cartridge 70 from the contact unit 310. Additionally, for example, some contacts of the contact unit 310 can be provided in the drum cartridge 40, and the other contacts of the contact unit 310 can be provided in the development cartridge 70.

Moreover, the development unit 15 and the toner cartridge C in the above-described embodiments can be integrated with each other and be configured as a toner container (development cartridge) which is independent from the cleaning unit 10 and attachable to and detachable from the apparatus main body 1A.

Moreover, in the above-described embodiments, a configuration in which the toner cartridge C is mounted to the apparatus main body 1A after the process cartridge B is attached to the apparatus main body 1A has been described. The present disclosure is not limited to this, and a configuration in which the toner cartridge C (toner container) is preliminarily mounted to the process cartridge B (cartridge) and, then, the process cartridge B with the toner cartridge C mounted thereto is mounted to the apparatus main body 1A can be employed.

### Summary of Present Disclosure

The present disclosure includes at least the following contents.

### <Configuration 1>

An image forming apparatus including:
an apparatus main body;
a transfer roller;
a cartridge which is attachable to and detachable from the apparatus main body in a first direction intersecting with a direction of gravitational force, the cartridge including:
a photosensitive drum which rotates around a rotational axis extending in a second direction intersecting with both the first direction and the direction of gravitational force, the photosensitive drum being configured to form a transfer nip portion for transferring a toner image to a recording material in conjunction with the transfer roller;
a blade which is in abutting contact with the photosensitive drum, the blade being configured to scrape residual toner remaining on the photosensitive drum without being transferred to the recording material; and
a development roller configured to supply toner to the photosensitive drum;
a toner container which is attachable to and detachable from the apparatus main body, the toner container being configured to contain toner to be supplied to the cartridge;
a residual toner container which is attachable to and detachable from the apparatus main body in the second direction independently from the toner container and is configured to contain the residual toner scraped from the photosensitive drum by the blade, the residual toner container being provided at one end portion in the second direction of the apparatus main body; and
a first exterior member which covers an end surface in the second direction of the one end portion of the apparatus main body from outside,
wherein the residual toner container is provided with a second exterior member which covers the end surface of the apparatus main body from outside.

### <Configuration 2>

The image forming apparatus as set forth in Configuration 1, wherein the transfer roller is provided in the apparatus main body.

### <Configuration 3>

The image forming apparatus as set forth in Configuration 1 or 2,
wherein the first exterior member includes an opening portion, and
wherein the residual toner container is attached to and detached from the apparatus main body via the opening portion, and the second exterior member is mounted to the apparatus main body in such a way as to block the opening portion.

### <Configuration 4>

The image forming apparatus as set forth in any one of Configurations 1 to 3, wherein a first surface facing in the second direction of the first exterior member and a second surface facing in the second direction of the second exterior member are parallel to each other.

### <Configuration 5>

The image forming apparatus as set forth in Configuration 4, wherein the first surface of the first exterior member and the second surface of the second exterior member are on an identical plane.

### <Configuration 6>

The image forming apparatus as set forth in any one of Configurations 1 to 5, wherein colors of the first exterior member and the second exterior member are identical to each other.

### <Configuration 7>

The image forming apparatus as set forth in any one of Configurations 1 to 6, wherein a surface of the second exterior member is provided with a recessed portion a longitudinal direction of which is the first direction.

### <Configuration 8>

The image forming apparatus as set forth in any one of Configurations 1 to 7, wherein the cartridge includes a toner container which contains toner to be borne by the development roller, toner being resupplied to the toner container from the toner container.

### <Configuration 9>

The image forming apparatus as set forth in any one of Configurations 1 to 8, wherein the apparatus main body includes a main body housing which is provided with an opening and an opening and closing member which is movable between an opening position for opening the opening in such a way as to allow the cartridge and the toner container to be attached to and detached from the apparatus main body via the opening and a closing position for closing the opening.

### <Configuration 10>

The image forming apparatus as set forth in Configuration 9, wherein, in a case where the rotational axis is referred to as a first rotational axis, the opening and closing member is configured to be rotatable between the closing position and the opening position around a second rotational axis extending in the direction of gravitational force in another end portion located on a side opposite to the one end portion of the apparatus main body in the second direction.

### <Configuration 11>

The image forming apparatus as set forth in any one of Configurations 1 to 9,
wherein the cartridge includes a first discharge portion which discharges the residual toner,
wherein the apparatus main body includes a conveyance unit which includes a first receiving portion, which receives the residual toner discharged from the first discharge portion, and a second discharge portion, which discharges the residual toner toward the residual toner container, and conveys the residual toner,
wherein the residual toner container includes a second receiving portion which receives the residual toner discharged from the second discharge portion,
wherein the first discharge portion of the cartridge is configured to, in attaching and detaching the cartridge to and from the apparatus main body, perform engagement and disengagement, respectively, in directions along the first direction with respect to the first receiving portion, and
wherein the second receiving portion of the residual toner container is configured to, in attaching and detaching the residual toner container to and from the apparatus main body, perform engagement and disengagement, respectively, in directions along the second direction with respect to the second discharge portion.

### <Configuration 12>

The image forming apparatus as set forth in Configuration 11,
wherein the cartridge includes a contact portion for receiving supplying of electric power from the apparatus main body,
wherein the contact portion and the first discharge portion are arranged at one end portion of the cartridge in the second direction, and
wherein the first discharge portion is arranged below the contact portion.

### <Configuration 13>

The image forming apparatus as set forth in Configuration 12, wherein the first discharge portion includes a discharge port which is open in a direction intersecting with the first direction and facing downward with respect to the direction of gravitational force.

### <Configuration 14>

The image forming apparatus as set forth in Configuration 12 or 13, wherein, as viewed in the direction of gravitational force, the contact portion and the first discharge portion overlap each other.

### <Configuration 15>

The image forming apparatus as set forth in any one of Configurations 12 to 14, wherein the contact portion includes a contact for applying a voltage to the development roller.

### <Configuration 16>

The image forming apparatus as set forth in any one of Configurations 11 to 15,
wherein the apparatus main body includes a first side plate having a surface facing in the second direction and provided on a first end side of the apparatus main body in the second direction and a second side plate having a surface facing in the second direction and provided on a second end side of the apparatus main body which is a side opposite to the first end side in the second direction, a mounting space for mounting of the cartridge therein being formed between the first side plate and the second side plate,
wherein the conveyance unit includes a penetration portion which penetrates through a hole provided in the first side plate,
wherein the first receiving portion is arranged on a side identical to that of the mounting space with respect to the first side plate in the second direction, and
wherein the second discharge portion is arranged on a side opposite to that of the mounting space with respect to the first side plate in the second direction.

### <Configuration 17>

The image forming apparatus as set forth in any one of Configurations 11 to 16,
wherein the cartridge includes a charging roller which electrically charges the photosensitive drum,
wherein, when, as viewed in the second direction, a virtual straight line passing through a rotational axis of the charging roller and the rotational axis of the photosensitive drum is referred to as a first straight line, a virtual straight line passing through a rotational axis of the development roller and the rotational axis of the photosensitive drum is referred to as a second straight line, and a virtual straight line parallel to the second straight line and passing through the rotational axis of the charging roller is referred to as a third straight line, a direction of the first straight line intersects with the first direction and a direction of the third straight line intersects with the direction of gravitational force, and
wherein at least a part of the first discharge portion is arranged at a downstream side in a mounting direction, in which the cartridge is mounted to the apparatus main body, in the first direction with respect to the first straight line and in a region below the third straight line.

### <Configuration 18>

The image forming apparatus as set forth in any one of Configurations 1 to 17, wherein the toner container mounted to the apparatus main body is positioned with respect to the apparatus main body with regard to the first direction and the direction of gravitational force and is positioned with respect to the cartridge with regard to the second direction.

### <Configuration 19>

The image forming apparatus as set forth in any one of Configurations 1 to 18, wherein the residual toner container includes a residual toner containing portion which is attachable to and detachable from a portion of the residual toner container with the second exterior member attached thereto.

### <Configuration 20>

An image forming apparatus including:
an apparatus main body;
a transfer roller;
a drum cartridge which is attachable to and detachable from the apparatus main body in a first direction intersecting with a direction of gravitational force, the drum cartridge including:
a photosensitive drum which rotates around a rotational axis extending in a second direction intersecting with both the first direction and the direction of gravitational force, the photosensitive drum being configured to form a transfer nip portion for transferring a toner image to a recording material in conjunction with the transfer roller; and
a blade which is in abutting contact with the photosensitive drum, the blade being configured to scrape residual toner remaining on the photosensitive drum without being transferred to the recording material;
a development cartridge which is attachable to and detachable from the drum cartridge and is attachable to and detachable from the apparatus main body while being mounted to the drum cartridge, the development cartridge including a development roller configured to supply toner to the photosensitive drum;
a residual toner container which is attachable to and detachable from the apparatus main body in the second direction independently from the drum cartridge and the development cartridge and is configured to contain the residual toner scraped from the photosensitive drum by the blade, the residual toner container being provided at one end portion in the second direction of the apparatus main body; and
a first exterior member which covers an end surface in the second direction of the one end portion of the apparatus main body from outside,
wherein the residual toner container is provided with a second exterior member which covers the end surface of the apparatus main body from outside.

### <Configuration 21>

The image forming apparatus as set forth in Configuration 20, wherein the transfer roller is provided in the apparatus main body.

### <Configuration 22>

The image forming apparatus as set forth in Configuration 20 or 21,
wherein the first exterior member includes an opening portion, and
wherein the residual toner container is attached to and detached from the apparatus main body via the opening portion, and the second exterior member is mounted to the apparatus main body in such a way as to block the opening portion.

### <Configuration 23>

The image forming apparatus as set forth in any one of Configurations 20 to 22, wherein a first surface facing in the second direction of the first exterior member and a second surface facing in the second direction of the second exterior member are parallel to each other.

### <Configuration 24>

The image forming apparatus as set forth in Configuration 23, wherein the first surface of the first exterior member and the second surface of the second exterior member are on an identical plane.

### <Configuration 25>

The image forming apparatus as set forth in any one of Configurations 20 to 24, wherein colors of the first exterior member and the second exterior member are identical to each other.

### <Configuration 26>

The image forming apparatus as set forth in any one of Configurations 20 to 25, wherein a surface of the second exterior member is provided with a recessed portion a longitudinal direction of which is the first direction.

### <Configuration 27>

The image forming apparatus as set forth in any one of Configurations 20 to 26, wherein the apparatus main body includes a main body housing which is provided with an opening and an opening and closing member which is movable between an opening position for opening the opening in such a way as to allow the drum cartridge and the development cartridge to be attached to and detached from the apparatus main body via the opening and a closing position for closing the opening.

### <Configuration 28>

The image forming apparatus as set forth in Configuration 27, wherein, in a case where the rotational axis is referred to as a first rotational axis, the opening and closing member is configured to be rotatable between the closing position and the opening position around a second rotational axis extending in the direction of gravitational force in another end portion located on a side opposite to the one end portion of the apparatus main body in the second direction.

### <Configuration 29>

The image forming apparatus as set forth in any one of Configurations 20 to 27,
wherein the drum cartridge includes a first discharge portion which discharges the residual toner,
wherein the apparatus main body includes a conveyance unit which includes a first receiving portion, which receives the residual toner discharged from the first discharge portion, and a second discharge portion, which discharges the residual toner toward the residual toner container, and conveys the residual toner,
wherein the residual toner container includes a second receiving portion which receives the residual toner discharged from the second discharge portion,
wherein the first discharge portion of the drum cartridge is configured to, in attaching and detaching the drum cartridge to and from the apparatus main body, perform engagement and disengagement, respectively, in directions along the first direction with respect to the first receiving portion, and
wherein the second receiving portion of the residual toner container is configured to, in attaching and detaching the residual toner container to and from the apparatus main body, perform engagement and disengagement, respectively, in directions along the second direction with respect to the second discharge portion.

### <Configuration 30>

The image forming apparatus as set forth in Configuration 29,
wherein at least one of the drum cartridge and the development cartridge includes a contact portion for receiving supplying of electric power from the apparatus main body,
wherein the contact portion and the first discharge portion are arranged at one end portion of at least one of the drum cartridge and the development cartridge in the second direction, and
wherein the first discharge portion is arranged below the contact portion.

### <Configuration 31>

The image forming apparatus as set forth in Configuration 30, wherein the first discharge portion includes a discharge port which is open in a direction intersecting with the first direction and facing downward with respect to the direction of gravitational force.

### <Configuration 32>

The image forming apparatus as set forth in Configuration 30 or 31, wherein, as viewed in the direction of gravitational force, the contact portion and the first discharge portion overlap each other.

### <Configuration 33>

The image forming apparatus as set forth in any one of Configurations 30 to 32, wherein the contact portion includes a contact for applying a voltage to the development roller.

### <Configuration 34>

The image forming apparatus as set forth in any one of Configurations 29 to 33,
wherein the apparatus main body includes a first side plate having a surface facing in the second direction and provided on a first end side of the apparatus main body in the second direction and a second side plate having a surface facing in the second direction and provided on a second end side of the apparatus main body which is a side opposite to the first end side in the second direction, a mounting space for mounting of the drum cartridge therein being formed between the first side plate and the second side plate,
wherein the conveyance unit includes a penetration portion which penetrates through a hole provided in the first side plate,
wherein the first receiving portion is arranged on a side identical to that of the mounting space with respect to the first side plate in the second direction, and
wherein the second discharge portion is arranged on a side opposite to that of the mounting space with respect to the first side plate in the second direction.

### <Configuration 35>

The image forming apparatus as set forth in any one of Configurations 29 to 34,
wherein the drum cartridge includes a charging roller which electrically charges the photosensitive drum,
wherein, when, as viewed in the second direction, a virtual straight line passing through a rotational axis of the charging roller and the rotational axis of the photosensitive drum is referred to as a first straight line, a virtual straight line passing through a rotational axis of the development roller and the rotational axis of the photosensitive drum is referred to as a second straight line, and a virtual straight line parallel to the second straight line and passing through the rotational axis of the charging roller is referred to as a third straight line, a direction of the first straight line intersects with the first direction and a direction of the third straight line intersects with the direction of gravitational force, and
wherein at least a part of the first discharge portion is arranged at a downstream side in a mounting direction, in which the drum cartridge is mounted to the apparatus main body, in the first direction with respect to the first straight line and in a region below the third straight line.

### <Configuration 36>

The image forming apparatus as set forth in any one of Configurations 20 to 35, wherein the residual toner container includes a residual toner containing portion which is attachable to and detachable from a portion of the residual toner container with the second exterior member attached thereto.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-224576 filed Dec. 19, 2024 and Japanese Patent Application No. 2025-062895 filed Apr. 7, 2025, which are hereby incorporated by reference herein in their entirety.

What is claimed is:

1. An image forming apparatus comprising:
an apparatus main body;
a transfer roller;
a cartridge which is attachable to and detachable from the apparatus main body in a first direction intersecting with a direction of gravitational force, the cartridge including:
a photosensitive drum which rotates around a rotational axis extending in a second direction intersecting with both the first direction and the direction of gravitational force, the photosensitive drum being configured to form a transfer nip portion for transferring a toner image to a recording material in conjunction with the transfer roller;
a blade which is in abutting contact with the photosensitive drum, the blade being configured to scrape residual toner remaining on the photosensitive drum without being transferred to the recording material; and
a development roller configured to supply toner to the photosensitive drum;
a toner container which is attachable to and detachable from the apparatus main body, the toner container being configured to contain toner to be supplied to the cartridge;
a residual toner container which is attachable to and detachable from the apparatus main body in the second direction independently from the toner container and is configured to contain the residual toner scraped from the photosensitive drum by the blade, the residual toner container being provided at one end portion in the second direction of the apparatus main body; and
a first exterior member which covers an end surface in the second direction of the one end portion of the apparatus main body from outside,
wherein the residual toner container is provided with a second exterior member which covers the end surface of the apparatus main body from outside.

2. The image forming apparatus according to claim 1, wherein the transfer roller is provided in the apparatus main body.

3. The image forming apparatus according to claim 1,
wherein the first exterior member includes an opening portion, and
wherein the residual toner container is attached to and detached from the apparatus main body via the opening portion, and the second exterior member is mounted to the apparatus main body in such a way as to block the opening portion.

4. The image forming apparatus according to claim 1, wherein a first surface facing in the second direction of the first exterior member and a second surface facing in the second direction of the second exterior member are parallel to each other.

5. The image forming apparatus according to claim 4, wherein the first surface of the first exterior member and the second surface of the second exterior member are on an identical plane.

6. The image forming apparatus according to claim 1, wherein colors of the first exterior member and the second exterior member are identical to each other.

7. The image forming apparatus according to claim 1, wherein a surface of the second exterior member is provided with a recessed portion a longitudinal direction of which is the first direction.

8. The image forming apparatus according to claim 1, wherein the cartridge includes a toner container which contains toner to be borne by the development roller, toner being resupplied to the toner container from the toner container.

9. The image forming apparatus according to claim 1, wherein the apparatus main body includes a main body housing which is provided with an opening and an opening and closing member which is movable between an opening position for opening the opening in such a way as to allow the cartridge and the toner container to be attached to and detached from the apparatus main body via the opening and a closing position for closing the opening.

10. The image forming apparatus according to claim 9, wherein, in a case where the rotational axis is referred to as a first rotational axis, the opening and closing member is configured to be rotatable between the closing position and the opening position around a second rotational axis extending in the direction of gravitational force in another end portion located on a side opposite to the one end portion of the apparatus main body in the second direction.

11. The image forming apparatus according to claim 1,
wherein the cartridge includes a first discharge portion which discharges the residual toner,
wherein the apparatus main body includes a conveyance unit which includes a first receiving portion, which receives the residual toner discharged from the first discharge portion, and a second discharge portion, which discharges the residual toner toward the residual toner container, and conveys the residual toner,
wherein the residual toner container includes a second receiving portion which receives the residual toner discharged from the second discharge portion,
wherein the first discharge portion of the cartridge is configured to, in attaching and detaching the cartridge to and from the apparatus main body, perform engagement and disengagement, respectively, in directions along the first direction with respect to the first receiving portion, and
wherein the second receiving portion of the residual toner container is configured to, in attaching and detaching the residual toner container to and from the apparatus main body, perform engagement and disengagement, respectively, in directions along the second direction with respect to the second discharge portion.

12. The image forming apparatus according to claim 11,
wherein the cartridge includes a contact portion for receiving supplying of electric power from the apparatus main body,
wherein the contact portion and the first discharge portion are arranged at one end portion of the cartridge in the second direction, and
wherein the first discharge portion is arranged below the contact portion.

13. The image forming apparatus according to claim 12, wherein the first discharge portion includes a discharge port which is open in a direction intersecting with the first direction and facing downward with respect to the direction of gravitational force.

14. The image forming apparatus according to claim 12, wherein, as viewed in the direction of gravitational force, the contact portion and the first discharge portion overlap each other.

15. The image forming apparatus according to claim 12, wherein the contact portion includes a contact for applying a voltage to the development roller.

16. The image forming apparatus according to claim 11,
wherein the apparatus main body includes a first side plate having a surface facing in the second direction and provided on a first end side of the apparatus main body in the second direction and a second side plate having a surface facing in the second direction and provided on a second end side of the apparatus main body which is a side opposite to the first end side in the second direction, a mounting space for mounting of the cartridge therein being formed between the first side plate and the second side plate,
wherein the conveyance unit includes a penetration portion which penetrates through a hole provided in the first side plate,
wherein the first receiving portion is arranged on a side identical to that of the mounting space with respect to the first side plate in the second direction, and
wherein the second discharge portion is arranged on a side opposite to that of the mounting space with respect to the first side plate in the second direction.

17. The image forming apparatus according to claim 11,
wherein the cartridge includes a charging roller which electrically charges the photosensitive drum,
wherein, when, as viewed in the second direction, a virtual straight line passing through a rotational axis of the charging roller and the rotational axis of the photosensitive drum is referred to as a first straight line, a virtual straight line passing through a rotational axis of the development roller and the rotational axis of the photosensitive drum is referred to as a second straight line, and a virtual straight line parallel to the second straight line and passing through the rotational axis of the charging roller is referred to as a third straight line, a direction of the first straight line intersects with the first direction and a direction of the third straight line intersects with the direction of gravitational force, and
wherein at least a part of the first discharge portion is arranged at a downstream side in a mounting direction, in which the cartridge is mounted to the apparatus main body, in the first direction with respect to the first straight line and in a region below the third straight line.

18. The image forming apparatus according to claim 1, wherein the toner container mounted to the apparatus main body is positioned with respect to the apparatus main body with regard to the first direction and the direction of gravitational force and is positioned with respect to the cartridge with regard to the second direction.

19. The image forming apparatus according to claim 1, wherein the residual toner container includes a residual toner containing portion which is attachable to and detachable from a portion of the residual toner container with the second exterior member attached thereto.

20. An image forming apparatus comprising:
an apparatus main body;
a transfer roller;
a drum cartridge which is attachable to and detachable from the apparatus main body in a first direction intersecting with a direction of gravitational force, the drum cartridge including:
a photosensitive drum which rotates around a rotational axis extending in a second direction intersecting with both the first direction and the direction of gravitational force, the photosensitive drum being configured to form a transfer nip portion for transferring a toner image to a recording material in conjunction with the transfer roller; and
a blade which is in abutting contact with the photosensitive drum, the blade being configured to scrape residual toner remaining on the photosensitive drum without being transferred to the recording material;
a development cartridge which is attachable to and detachable from the drum cartridge and is attachable to and detachable from the apparatus main body while being mounted to the drum cartridge, the development cartridge including a development roller configured to supply toner to the photosensitive drum;
a residual toner container which is attachable to and detachable from the apparatus main body in the second direction independently from the drum cartridge and the development cartridge and is configured to contain the residual toner scraped from the photosensitive drum by the blade, the residual toner container being provided at one end portion in the second direction of the apparatus main body; and
a first exterior member which covers an end surface in the second direction of the one end portion of the apparatus main body from outside,
wherein the residual toner container is provided with a second exterior member which covers the end surface of the apparatus main body from outside.

21. The image forming apparatus according to claim 20, wherein the transfer roller is provided in the apparatus main body.

22. The image forming apparatus according to claim 20,
wherein the first exterior member includes an opening portion, and
wherein the residual toner container is attached to and detached from the apparatus main body via the opening portion, and the second exterior member is mounted to the apparatus main body in such a way as to block the opening portion.

23. The image forming apparatus according to claim 20, wherein a first surface facing in the second direction of the first exterior member and a second surface facing in the second direction of the second exterior member are parallel to each other.

24. The image forming apparatus according to claim 23, wherein the first surface of the first exterior member and the second surface of the second exterior member are on an identical plane.

25. The image forming apparatus according to claim 20, wherein colors of the first exterior member and the second exterior member are identical to each other.

26. The image forming apparatus according to claim 20, wherein a surface of the second exterior member is provided with a recessed portion a longitudinal direction of which is the first direction.

27. The image forming apparatus according to claim 20, wherein the apparatus main body includes a main body housing which is provided with an opening and an opening and closing member which is movable between an opening position for opening the opening in such a way as to allow the drum cartridge and the development cartridge to be attached to and detached from the apparatus main body via the opening and a closing position for closing the opening.

28. The image forming apparatus according to claim 27, wherein, in a case where the rotational axis is referred to as a first rotational axis, the opening and closing member is configured to be rotatable between the closing position and the opening position around a second rotational axis extending in the direction of gravitational force in another end portion located on a side opposite to the one end portion of the apparatus main body in the second direction.

29. The image forming apparatus according to claim 20,
wherein the drum cartridge includes a first discharge portion which discharges the residual toner,
wherein the apparatus main body includes a conveyance unit which includes a first receiving portion, which receives the residual toner discharged from the first discharge portion, and a second discharge portion, which discharges the residual toner toward the residual toner container, and conveys the residual toner,
wherein the residual toner container includes a second receiving portion which receives the residual toner discharged from the second discharge portion,
wherein the first discharge portion of the drum cartridge is configured to, in attaching and detaching the drum cartridge to and from the apparatus main body, perform engagement and disengagement, respectively, in directions along the first direction with respect to the first receiving portion, and
wherein the second receiving portion of the residual toner container is configured to, in attaching and detaching the residual toner container to and from the apparatus main body, perform engagement and disengagement, respectively, in directions along the second direction with respect to the second discharge portion.

30. The image forming apparatus according to claim 29,
wherein at least one of the drum cartridge and the development cartridge includes a contact portion for receiving supplying of electric power from the apparatus main body,
wherein the contact portion and the first discharge portion are arranged at one end portion of at least one of the drum cartridge and the development cartridge in the second direction, and
wherein the first discharge portion is arranged below the contact portion.

31. The image forming apparatus according to claim 30, wherein the first discharge portion includes a discharge port which is open in a direction intersecting with the first direction and facing downward with respect to the direction of gravitational force.

32. The image forming apparatus according to claim 30, wherein, as viewed in the direction of gravitational force, the contact portion and the first discharge portion overlap each other.

33. The image forming apparatus according to claim 30, wherein the contact portion includes a contact for applying a voltage to the development roller.

34. The image forming apparatus according to claim 29,
wherein the apparatus main body includes a first side plate having a surface facing in the second direction and provided on a first end side of the apparatus main body in the second direction and a second side plate having a surface facing in the second direction and provided on a second end side of the apparatus main body which is a side opposite to the first end side in the second direction, a mounting space for mounting of the drum cartridge therein being formed between the first side plate and the second side plate,
wherein the conveyance unit includes a penetration portion which penetrates through a hole provided in the first side plate,
wherein the first receiving portion is arranged on a side identical to that of the mounting space with respect to the first side plate in the second direction, and
wherein the second discharge portion is arranged on a side opposite to that of the mounting space with respect to the first side plate in the second direction.

35. The image forming apparatus according to claim 29,
wherein the drum cartridge includes a charging roller which electrically charges the photosensitive drum,
wherein, when, as viewed in the second direction, a virtual straight line passing through a rotational axis of the charging roller and the rotational axis of the photosensitive drum is referred to as a first straight line, a virtual straight line passing through a rotational axis of the development roller and the rotational axis of the photosensitive drum is referred to as a second straight line, and a virtual straight line parallel to the second straight line and passing through the rotational axis of the charging roller is referred to as a third straight line, a direction of the first straight line intersects with the first direction and a direction of the third straight line intersects with the direction of gravitational force, and
wherein at least a part of the first discharge portion is arranged at a downstream side in a mounting direction, in which the drum cartridge is mounted to the apparatus main body, in the first direction with respect to the first straight line and in a region below the third straight line.

36. The image forming apparatus according to claim 20, wherein the residual toner container includes a residual toner containing portion which is attachable to and detachable from a portion of the residual toner container with the second exterior member attached thereto.
